(19) United States
(12) Patent Application Publication
(10) Pub. No.: US 2024/0262937 A1
(43) Pub. Date: Aug. 8, 2024

(54) Preparation of Chitin Nanocrystals and Nanowhiskers from Crustacean Biomass Using Ionic Liquid

(71) Applicant: Texas Tech University System, Lubbock, TX (US)

(72) Inventors: Julia L. Shamshina, Lubbock, TX (US); Noureddine Abidi, Lubbock, TX (US)

(21) Appl. No.: 18/626,439

(22) Filed: Apr. 4, 2024

Related U.S. Application Data
(63) Continuation-in-part of application No. PCT/US2022/045177, filed on Sep. 29, 2022.
(60) Provisional application No. 63/253,307, filed on Oct. 7, 2021.

(51) Int. Cl. C08B 37/08; B82Y 40/00; C08B 37/00

(52) U.S. Cl. CPC C08B 37/003; B82Y 40/00; C08B 37/0003

(57) ABSTRACT

Provided herein are methods for the preparation of chitin nanocrystals, nanowhiskers, or both directly from a raw chitinous biomass without the prior isolation of a raw chitin polymer using an ionic liquid comprising: drying the raw chitinous biomass; and extracting in a single step a purified chitin by hydrolyzing with an ionic liquid from a raw, unpurified chitinous biomass, wherein the chitin nanocrystals and nanowhiskers comprise at least one of a high aspect ratio, are highly crystalline, or have high thermal stability.

### CROSS-REFERENCE TO RELATED APPLICATIONS

This application claims priority to and is a continuation-in-part of International Application No. PCT/US2022/045177, filed Sep. 29, 2022, which claims priority to U.S. Provisional Application Ser. No. 63/253,307, filed Oct. 7, 2021, the entire contents of which are incorporated herein by reference.

### TECHNICAL FIELD OF THE INVENTION

The present invention relates in general to the field of preparing chitin nanocrystals and/or nanowhiskers (chitin derivatives that differ in dimensions), and more particularly, to a novel method for preparing chitin nanocrystals and nanowhiskers from chitinous biomass using ionic liquids in a single step.

### STATEMENT OF FEDERALLY FUNDED RESEARCH

None.

### BACKGROUND OF THE INVENTION

Chitin in nanostructure form (nanochitin) has proven to be one of the most significant green materials in recent years due to its intrinsic properties (high specific surface area, surface energy, high tensile strength, lyotropic liquid crystalline (LCP) behavior, and high thermal stability), renewability, and abundance.⁵⁶ Nanochitin is lightweight (density of 1.425 g cm⁻³),⁵⁷ has high longitudinal elastic modulus (λ, theoretical value >150 GPa)⁵⁸ and its specific stiffness, defined as the modulus-to-density ratio (105 GPa/(g cm⁻³)), is larger than that of metals, ceramics, or even Kevlar, suggesting that nanochitin could be used to fabricate lightweight exceptionally strong materials. Applications of nanochitin include automotive body and interior,⁵⁶ packaging and coatings,⁵⁹ reinforcement nanofillers,⁶⁰⁻⁶³ cement and concrete strength and durability enhancers⁶⁴⁻⁶⁵ plastic packaging replacements,⁶⁶ plastic film replacements,⁶⁷ hygiene absorbent products,⁸⁵ etc. Emerging applications include medical,⁶⁹⁻⁷² sensors (medical,⁷³ environmental,⁷⁴ industrial,⁷⁵ and diagnostics), water and air filtration,⁷⁶⁻⁷⁷ exfoliants in personal-care and cosmetics products,⁷⁸ flexible electronics79⁰ and self-cleaning materials.⁸⁰

Nanochitin can be produced from shrimp shell waste. Shrimp shell waste contains about 70% head and 30% shell.⁸¹ Waste management is a huge problem faced by the seafood industries which consider these huge volumes of effluents and solid waste as a burden because they are potential environmental hazards.⁸² Most of this waste is dumped back into the ocean or is disposed of in landfills or subjected to incineration. Landfill can contribute to climate change about 10 times more than other waste disposal options, and ocean dumping results in reduced oxygen levels at the ocean bottom. Other environmental issues include biotic depletion and water acidification.

Acquiring nanochitin from biomass proceeds in two steps. First, the chitinous material needs to be deconstructed to recover purified “bulk” chitin, alone and as pure as possible. Second, “bulk” chitin will have to be treated to yield nanostructured material. The chitinous shell matrix structure is such that the strong covalent and hydrogen bonds between layers of proteins, minerals, and chitin prevent easy access to chitin itself, thus conferring to crustaceans their ability to protect themselves and also preventing chemical degradation. Once pure chitin is isolated, further treatment is needed to recover nanochitin. The second step typically involves the use of strong acids, to hydrolyze the polymer. In acid hydrolysis, the hydronium ions penetrate the amorphous regions of chitin polymer chains and hydrolytically cleave glycosidic bonds, to release individual acid-resistant crystallized chitin nanoparticles.^{29,30,83-86} The only nanochitin production company, Boco Technology, Inc. (Toronto, Canada) has commercialized the preparation of nanochitin from “bulk” chitin and holds the exclusive patent for its preparation and use (e.g., as a reinforcing material in plastics).⁸⁷

The reason for the process of nanochitin production not being widely adapted is that the first step, the current industrial method for “bulk” chitin recovery is destructive, wasteful, and expensive. It involves demineralization to remove minerals present in a shell matrix (using acids, e.g., HCl)), deproteinization to remove proteins (using bases, e.g., NaOH)), and bleaching/discoloration (conducted with organic solvents⁸⁸ or oxidation agents⁸⁹. These steps are conducted at relatively high temperatures (60-100° C.), and usually for a prolonged time,^{90,91} utilizing an overall 1.2 kWh of electricity and generating >500 L acidic and basic waste per 1 kg of “bulk” chitin. In this process, 677 kg CO₂ equiv. of CO₂ footprint comes from this step (incl. milling, demineralization, deproteinization, washing, and drying). The second step, nanochitin production via hydrolysis, involves the treatment of “bulk” chitin with 3 N additional amount of HCl or H₂SO₄, for the removal of disordered regions of the polymer^{92,93} 229.8 kg CO₂ equiv.⁸¹ comes from nanochitin production step. This scale of waste chemicals is environmentally problematic and proper disposal is costly. Both the high cost involved in the production of nanochitin and the huge quantity of generated waste resulted in the pulping process raising public and governmental concerns, and no nanochitin-producing plant that uses acid/base treatment on the territory of the US.⁹⁵

The preparation of nanochitin straight from biomass waste eliminating recovery of “bulk” chitin would address a critical sustainability gap in the preparation of chitin nanomaterials. Greatly expanded US markets are possible for chitin and related products if one can reliably obtain high-quality chitin nanochitin from crustacean waste in a single step, and isolate nanochitin using a minimal amount of energy, water, and chemical reagents.

Without limiting the scope of the invention, its background is described in connection with chitin. Chitin nanocrystals and nanowhiskers are derivatives of chitin and are typically obtained through acid hydrolysis of chitin.

Chitin. Chitin is one of the main components in the exoskeleton of shellfish. Wastes from crab, lobster, crayfish, shrimp, and krill are the most important source of chitin. Chitin is also present in insects and cell walls of fungi,² skeleton of sponges, inner skeleton of squid and cuttlefish, mushrooms, and insects (such as fly larvae). In crustacean biomass, chitin content ranges between 8 and 40%,¹ in mushrooms chitin content is less than 20%, and in insects up to 20%. Chitin is a linear polysaccharide, and the second most abundant natural polymer after cellulose.³ This natural polymer is made of N-acetyl-D-glucose-2-amine units that are linked together in β-1,4 manner. Native chitin is highly crystalline and occurs in three forms that depend on its origin and are identified as α-, ρ- and γ-chitin. Chitin from shrimp shells is α-form. In both α- and β-forms, the chitin chains are organized in sheets where they are tightly held by a number of intra-sheet hydrogen bonds, but in α-chitin, all chains are arranged in an antiparallel fashion.^{5,6}

The various forms of chitin can be differentiated by powder X-ray diffraction (pXRD) technique, Fourier-Transform Infrared Spectroscopy (FTIR), and Solid-state Cross-Polarization Magic Angle Spinning Carbon-13 Nuclear Magnetic Resonance (CP/MAS—NMR) Spectroscopy.⁷ Hierarchical fibrillar structure of chitin is as follows: at the molecular level it is the polymeric chain, and arrangement of 18-25 of such chains in the form of narrow and long crystalline units form nanofibrils with a diameter ranging from 2.5 to 2.8 nm and about 300-500 nm length. These nanofibrils are clustered into chitin-protein microfibrils of about 25-300 nm in diameter.⁸ In crustacean biomass, the matrix that surrounds chitinous tissues contains proteins and is extensively mineralized (e.g., crustacean shells), whereas in insect biomass chitin exist with proteins, and in mushrooms chitin co-exists with glucans.

In industrial processing, chitin is extracted from chitinous biomass by alkaline treatment (deproteinization) to solubilize proteins and by acid treatment (demineralization) to dissolve minerals.⁹ Sometimes, a decolorization is also carried out to remove astaxanthin pigment. Ionic liquids are also used for isolation of pure chitin using a series of extraction steps (i.e., with 1-ethyl-3-methylimidazolium acetate [C₂mim][OAc]). The chitin derivative, chitosan, is a deacetylated form of chitin produced by reflux of chitin in excess sodium hydroxide aqueous solution.² Thus, it is a linear polysaccharide composed of randomly distributed 0-(1,4)-linked D-glucosamine (deacetylated unit) and N-acetyl-D-glucosamine (acetylated unit). Chitosan it is not relevant to the present invention.

Ionic liquids thus far have been used for dissolution of chitin (i.e., as solvents for chitin),¹⁵ and extraction of chitin through solubilization of the polymer in ionic liquids. These so-called “dissolving” ILs (see, e.g., U.S. Patent Publication No. 20190040209) are used for the isolation of purified chitin polymer, but not for formation of nanocrystals and nanowhiskers. If chitin is solubilized, the prepared solutions subsequently enable the products technology platform based on “solution processing” (shaping chitin solutions into different materials).¹⁶⁻²³ For dissolution of chitin to occur, this hydrogen bonding network of the polymer first needs to get disrupted.

Another type of ILs is so-called “pulping” ILs (Patent No. 10,100,131) that are used to isolate chitin polymer.

The only art uses the formation of nanowhisker-films (not individual whiskers) from purified chitin using 1-allyl-3-methylimidazolium bromide IL,²⁴ prepared through initial dissolution of chitin, coagulation with methanol, and formation of gels. This dissolution method utilizes pure chitin polymer, and not biomass.

Preparation of Chitin Nanowhiskers from Purified Chitin. The preparation of chitin nanofibers or nanocrystals and nanowhiskers from the complex hierarchy of chitinous biomass involves various steps. Chitin does not occur alone in living organisms, but always coexists with some other compounds. As opposed to cellulose, where two other components of biomass, hemicellulose and lignin (which are also polymeric by nature and can easily undergo hydrolysis simultaneously with cellulose), chitinous biomass contains proteins and (often but not always) minerals, that must be removed prior to making nanocrystals and nanowhiskers. At present, the major sources of chitin in industry are the shell wastes of crabs and shrimps. The shell wastes are mainly made up of chitin (20-30%), proteins (30-40%), calcium carbonate (30-50%), and lipids and astaxanthin (<1%).²⁵ Overall process for preparation of chitin from shell wastes usually includes four main steps, as shown in FIG. 1B (Prior Art), which requires: (1) removal of proteins with dilute NaOH (deproteinization), (2) removal of minerals in dilute HCl (demineralization), (3) extraction of astaxanthin and lipids with organic solvents such as acetone and ethanol (decolorization), and often (4) bleaching with NaClO to obtain purified chitin. The purified chitin can be used in preparation of suspension of chitin whiskers in strong acid aqueous medium.

Therefore, all methods include the preparation of purified chitin prior to preparation of nanocrystals and nanowhiskers. The extra step of chitin isolation adds cost and thus for practical commodity materials and applications, it would be advantageous to be able to conduct preparation of nanocrystals and nanowhiskers directly from the original chitinous biomass. There are few reports where nanocrystals and nanowhiskers seem to be produced from biomass (see a Table from reference [26]), however, the thorough analysis revealed that purified chitin was first isolated prior ChNCs preparation in all reported cases (Table 1), and from the biomass source was provided, to distinguish between chitins of different origins. Obtained chitin was processed by acid hydrolysis, TEMPO, or other types (i.e., periodinate) of oxidations. There are many cases of chitin nanowhiskers production in literature and Table 1 is, by no means, an exhaustive and/or complete list of reported methods, but rather provides few representative examples.

TABLE 1
Prior extraction methods from purified chitin

| Nr. | Biomass Used | Extraction method | Length (nm) | Width (nm) | Ref. |
|---|---|---|---|---|---|
| 1 | Riftia tubes | First preparation of chitin: | 500-10000 | 18 | 27 |
| | (chitin is first | deproteinization, | (A = 2200) | | |
| | obtained) | bleaching to obtain chitin | | | |
| | | and then hydrochloric | | | |
| | | acid hydrolysis | | | |
| 2 | Shrimp shell | First preparation of chitin | 400 | 25-32 | 28 |
| | (see paper, | by oxalic acid (1:10 | | | |
| | chitin is first | g/mL), then | | | |
| | obtained) | demineralization, | | | |
| | | hydrogen peroxide | | | |
| | | deproteinization, and only | | | |
| | | then hydrochloric acid | | | |
| | | hydrolysis | | | |
| 3 | Shrimp shell | Hydrochloric acid | NR | NR | 29 |
| | chitin | hydrolysis | | | |
| 4 | Technical crab | Hydrochloric acid | 50-300 | 6-8 | 30 |
| | shell chitin | hydrolysis | (A = 150) | (A = 10) | |
| 5 | Crab shell | Hydrochloric acid | 100-600 | 4-40 | 31a |
| | chitin | hydrolysis | (A = 240) | (A = 15) | |
| 6 | Crab shell | Hydrochloric acid | 100-650 | 10-80 | 18ej |
| | chitin | hydrolysis | (A = 500 ± 50) | (A = 50 ± 10) | |
| 7 | Crab shell | Hydrochloric acid | 110-975 | 8-73 | 18m |
| | chitin | hydrolysis | (A = 343) | (A = 46) | |
| 8 | Purified chitin | Hydrochloric acid | 50-300 | 10 | 18Error! |
| | | hydrolysis | (A = 150) | | Bookmark |
| | | | | | not |
| | | | | | defined.q |
| 9 | Crab shell | Hydrochloric acid | 200-500 | 5-20 | 32 |
| | chitin | hydrolysis | | | |
| 10 | Squid pen | TEMPO-mediated | few microns | 3-4 | 33 |
| | chitin | oxidation | | | |
| 11 | Crab shell | TEMPO-mediated | 340 | 8 | 34 |
| | chitin | oxidation, ultrasonic | | | |
| | | treatment | | | |
| 12 | Crab shell | Periodate-anions mediated | 227 | 7-17 | 35, 36 |
| | chitin | oxidation | | | |
| 13 | Shrimp shell | Periodate-anions mediated | 240 | 7-17 | 23 |
| | chitin | oxidation | | | |
| 14 | Crab shell | Ammonium persulfate | 400-500 | 15 | 37 |
| | chitin | (APS) | | | |
| 15 | Shrimp shell | DES (Betaine | 100-500 | 4-17 | 38 |
| | chitin | hydrochloride + FeCl₃ × | | | |
| | | 6H₂O), methanol | | | |

Acid Hydrolysis (at least 56 literature examples): This method for preparing chitin nanocrystals and nanowhiskers involves hydrolysis of purified chitin polymer in strong acid aqueous medium. Before preparing chitin nanocrystals and nanowhiskers, chitin has to be isolated or extracted from biomass. 2,2,6,6-tetramethylpiperidine-1-oxyl radical (TEMPO)-mediated oxidation: Chitin nanocrystals and nanowhiskers were also prepared from pure chitin by 2,2,6,6-tetramethylpiperidine-1-oxyl radical (TEMPO)-mediated oxidation of α-chitin in water at pH 10. Periodate-anions mediated oxidation: For isolating nanocrystals and nanowhiskers from chitin-containing starting material (chitin is used in the example) chitin was exposed to an oxidative effect of periodate anions in an aqueous suspension with pH>7.0, for a period of at least one day (in the actual patent 60% yield was obtained after 30 days). Persulfate oxidation: Chitin flakes are oxidized by ammonium persulfate oxidant with vigorous stirring. Deep Eutectic Solvents (DES): Alpha α-chitin from shrimp shells, betaine hydrochloride and ferric chloride hexahydrate are continuously mixed to prepare DES, chitin is added in, and heated.

Despite these advancements, a need remains for novel methods for making chitin nanocrystals and nanowhiskers.

### SUMMARY OF THE INVENTION

In one embodiment, the present invention includes a method for the preparation of chitin nanocrystals and nanowhiskers directly from a raw chitinous biomass without the prior isolation of a raw chitin polymer using an ionic liquid comprising: isolating chitin nanocrystals and nanowhiskers by hydrolyzing a raw, unpurified chitinous biomass with an ionic liquid, wherein the chitin nanocrystals and nanowhiskers comprise at least one of a high aspect ratio, are highly crystalline, or have high thermal stability. In one aspect, the ionic liquid comprises at least one cation and at least one anion that form an ion pair or an ion complex. In another aspect, the ionic liquid comprises an acidic ionic liquid, a Brönsted acidic ionic liquid, comprising one or more cations and one or more anions. In another aspect, the anion for the ionic liquid cation is a Bronsted-acidic anion (acidic IL), wherein,
the acidic IL is with [HSO₄]⁻-anion;

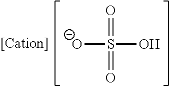

the acidic IL is with [RSO₄]⁻-anion, where R=C1-C6 alkyl or a C1-C6 alkoxyalkyl group, or substituted alkyl/alkoxyalkyl

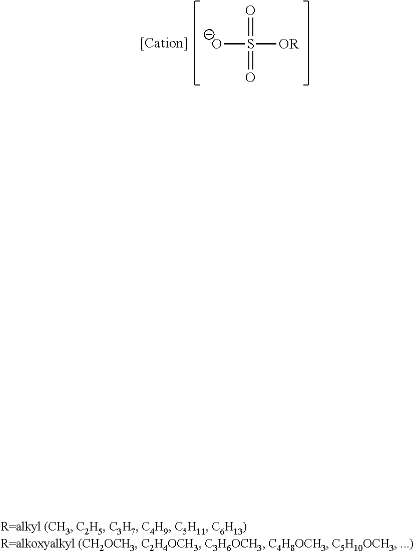

the acidic IL is with [HSO₃]⁻-anion;

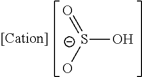

the acidic IL is with [RSO₃]⁻-anion, where R=C1-C6 alkyl or a C1-C6 alkoxyalkyl group, or substituted alkyl/alkoxyalkyl

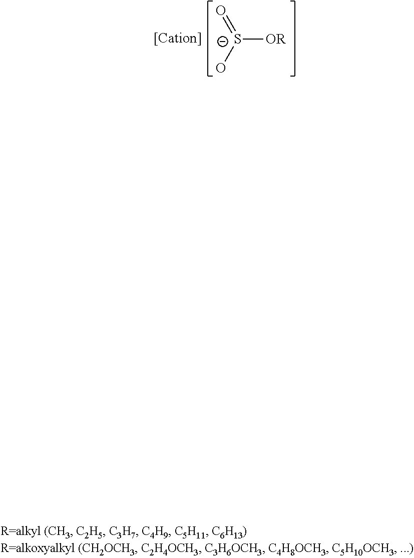

the acidic IL is with [H₂PO₄]⁻-anion;

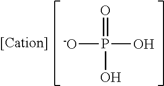

the acidic IL is with [R₁R₂PO₄]⁻-anion, where R₁ and R₂=independently C1-C6 alkyl or a C1-C6 alkoxyalkyl group, or substituted alkyl/alkoxyalkyl;

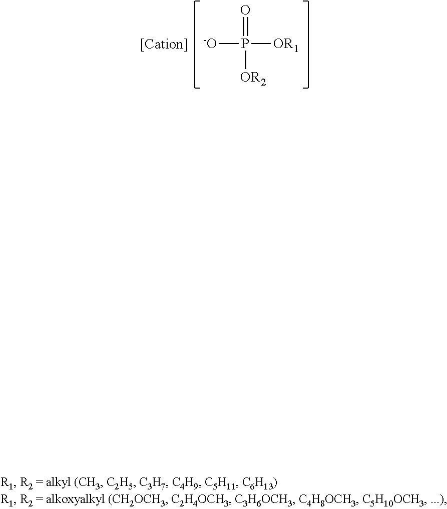

the acidic IL is with [NO_{3]}⁻-anion;

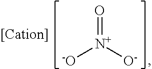

or combinations thereof.

In another aspect, the cation is selected from: imidazolium or substituted imidazolium, specifically, 1-methyl-3-butylimidazolium and 1-methylimidazolium,

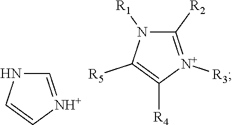

ammonium or substituted ammonium, specifically, triethyl ammonium,

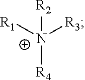

pyridinium or substituted pyridinium

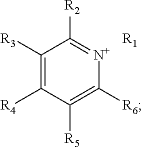

Brönsted acidic ionic liquids with acidic hydrogens on a functional group alkane sulfonic acid group SO₃H is covalently tethered to the IL cation

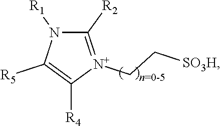

protic acidic ionic liquids with acidic hydrogens on cation and anion, or combinations thereof.

In another aspect, the ionic liquid is 1-butyl-3-methylimidazolium hydrogen sulfate. In another aspect, the raw chitinous biomass comprises at least one of: shrimp shell biomass, crab biomass, lobster biomass, squid pen, fly larvae, or a mixture thereof. In another aspect, the ionic liquid is selected from 1-butyl-3-methylimidazolium [C₄mim] salt. In another aspect, the ionic liquid is selected from at least one of: 1-methylimidazolium, 1-ethylimidazolium, 1-propylimidazolium, 1-butylimidazolium, 1-heptyl-3-methylimidazolium, 1-(cyclohexylmethyl)-3-methylimidazolium, 1-benzyl-3-methylimidazolium, 1,3-dibenzylimidazolium, 1-(2-napthylmethyl)-3-methylimidazolium, or 1, 3-dibenzylimidazolium, and mixtures or combination thereof. In another aspect, the ionic liquid comprise an acetate salt as the anion is selected from at least one of 1-hepyl-3-methylimidazolium acetate ([C7C1im][OAc]), 1-(cyclohexylmethyl)-3-methylimidazolium acetate ([CyhmC1im][OAc]), 1-benzyl-3-methylimidazolium acetate ([BnzC1im][OAc]), 1,3-dibenzylimidazolium acetate ([(Bnz)2im][OAc]), and 1-(2-napthylmethyl)-3-methylimidazolium acetate ([NapmC1im][OAc]), and mixtures or combination thereof. In another aspect, the ionic liquid is a halogen substituted 1-hepyl-3-methylimidazolium halide (X) ([C7C1im]X), 1-(cyclohexylmethyl)-3-methylimidazolium halide ([CyhmC1im]X), 1-benzyl-3-methylimidazolium halide ([BnzC1im]), 1,3-dibenzylimidazolium halide ([(Bnz)2im]X), and 1-(2-napthylmethyl)-3-methylimidazolium halide ([NapmC1im]X), 1-methylimidazolium halide, 1-ethylimidazolium halide, 1-propylimidazolium halide, or 1-butylimidazolium halide, and mixtures or combination thereof. In another aspect, the purified chitin comprises rod- or whisker-shaped particles. In another aspect, a product from a treatment of chitinous biomass with IL comprises rod- or whisker-shaped particles have dimensions selected from at least one of: 5-20 nm in width, 50-500 nm in length or a high aspect ratio (10-100). In another aspect, a yield of chitin nanowhiskers from the raw chitinous biomass is at least 40, 50, 60, or 70%. In another aspect, the chitin nanowhiskers comprise rod- or whisker-shaped particles have at least one of: a high aspect ratio, a high modulus (200 GPa), a high stiffness, a high strength, non-toxic, biodegradable, forms crystals, biocompatible, a high binding energy, or a liquid-crystalline behavior. In another aspect, the method further comprises one or more of the following step: mixing the chitinous biomass with an ionic liquid; addition of water; heating the biomass in the IL; washing resultant nanocrystals and nanowhiskers with water; or centrifuging the nanocrystals and nanowhiskers.

In another embodiment, the present invention includes a method for the preparation of chitin nanocrystals and nanowhiskers directly from a raw chitinous biomass without the prior isolation of a raw chitin polymer using an ionic liquid comprising: isolating in a single step a purified chitin nanowhiskers by hydrolyzing chitin in an unpurified chitinous biomass, wherein the chitin nanocrystals and nanowhiskers comprise at least one of a high aspect ratio, are highly crystalline, or high thermal stability. In one aspect, the ionic liquid is an acidic ionic liquid, a Brönsted acidic ionic liquid, with one or more cations and one or more anions. In another aspect, the anion for the ionic liquid cation is a Bronsted-acidic anion (acidic IL), wherein,
the acidic IL is with [HSO₄]⁻-anion;

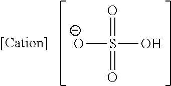

the acidic IL is with [RSO₄]⁻-anion, where R=C1-C6 alkyl or a C1-C6 alkoxyalkyl group, or substituted alkyl/alkoxyalkyl

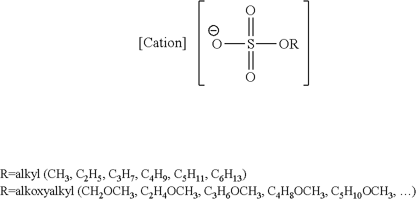

the acidic IL is with [HSO₃]⁻-anion;

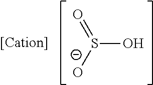

the acidic IL is with [RSO₃]⁻-anion, where R=C1-C6 alkyl or a C1-C6 alkoxyalkyl group, or substituted alkyl/alkoxyalkyl

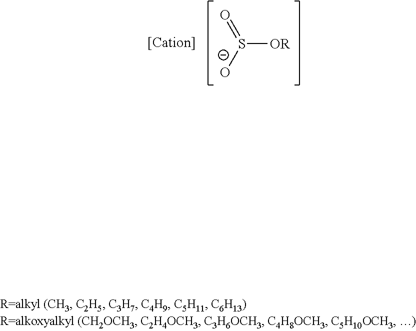

the acidic IL is with [H₂PO₄]⁻-anion;

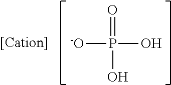

the acidic IL is with [R₁R₂PO₄]⁻-anion, where R₁ and R₂=independently C1-C6 alkyl or a C1-C6 alkoxyalkyl group, or substituted alkyl/alkoxyalkyl;

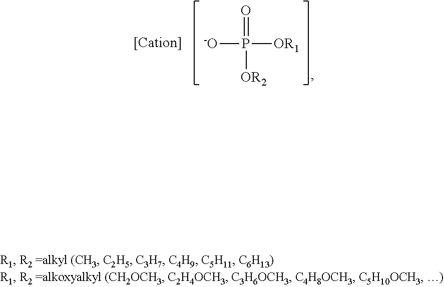

or the acidic IL is with [NO_{3]}⁻-anion;

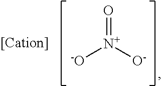

or combinations thereof.

In another aspect, the cation is selected from:
imidazolium or substituted imidazolium

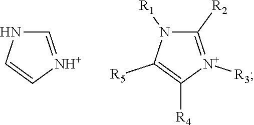

ammonium or substituted ammonium

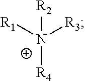

pyridinium or substituted pyridinium

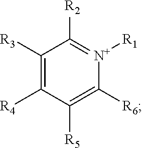

Brönsted acidic ionic liquids with acidic hydrogens on a functional group
alkane sulfonic acid group —SO₃H is covalently tethered to the IL cation

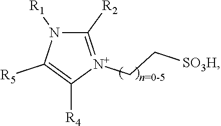

protic acidic ionic liquids with acidic hydrogens on cation and anion, or combinations thereof.

In another aspect, the ionic liquid is 1-ethyl-3-methylimidazolium hydrogen sulfate. In another aspect, the raw chitinous biomass comprises at least one of: shrimp shell biomass, crab biomass, lobster biomass, squid pen, fly larvae, or a mixture thereof. In another aspect, the ionic liquid is selected from 1-ethyl-3-methylimidazolium [C₂mim] salt. In another aspect, the ionic liquid is selected from at least one of: 1-methylimidazolium, 1-ethylimidazolium, 1-propylimidazolium, 1-butylimidazolium, 1-heptyl-3-methylimidazolium, 1-(cyclohexylmethyl)-3-methylimidazolium, 1-benzyl-3-methylimidazolium, 1,3-dibenzylimidazolium, 1-(2-napthylmethyl)-3-methylimidazolium, or 1, 3-dibenzylimidazolium, and mixtures or combination thereof. In another aspect, the ionic liquid comprise an acetate salt as the anion is selected from at least one of 1-hepyl-3-methylimidazolium acetate ([C7C1im][OAc]), 1-(cyclohexylmethyl)-3-methylimidazolium acetate ([CyhmC1im][OAc]), 1-benzyl-3-methylimidazolium acetate ([BnzC1im][OAc]), 1,3-dibenzylimidazolium acetate ([(Bnz)2im][OAc]), and 1-(2-napthylmethyl)-3-methylimidazolium acetate ([NapmC1im][OAc]), and mixtures or combination thereof. In another aspect, the ionic liquid is a halogen substituted 1-hepyl-3-methylimidazolium halide (X) ([C7C1im]X), 1-(cyclohexylmethyl)-3-methylimidazolium halide ([CyhmC1im]X), 1-benzyl-3-methylimidazolium halide ([BnzC1im]), 1,3-dibenzylimidazolium halide ([(Bnz)2im]X), and 1-(2-napthylmethyl)-3-methylimidazolium halide ([NapmC1im]X), 1-methylimidazolium halide, 1-ethylimidazolium halide, 1-propylimidazolium halide, or 1-butylimidazolium halide, and mixtures or combination thereof. In another aspect, the purified chitin comprises rod- or whisker-shaped particles. In another aspect, the purified chitin comprises rod- or whisker-shaped particles have dimensions selected from at least one of: 5-20 nm in width, 50-500 nm in length or a high aspect ratio (10-100). In another aspect, a yield of chitin from the raw chitinous biomass is at least 40, 50, 60, or 70%. In another aspect, the purified chitin comprises rod- or whisker-shaped particles have at least one of: a high aspect ratio, a high modulus (200 GPa), a high stiffness, a high strength, non-toxic, biodegradable, forms crystals, biocompatible, a high binding energy, or a liquid-crystalline behavior. In another aspect, the method further comprises the step of mixing the purified chitin to form a regenerative polymer, a bio-degradable polymer, or both. In another aspect, the method further comprises one or more of the following step: mixing the purified chitin in water; heating the purified chitin; washing the purified chitin with water; or centrifuging the purified chitin.

In another embodiment, the present invention includes a purified chitin nanocrystal made by a single step method, wherein the purified chitin is separated from a raw chitinous biomass without the prior isolation of a raw chitin polymer, the method comprising: extracting a purified chitin by hydrolyzing with an ionic liquid from the raw chitinous biomass, wherein the chitin nanocrystals and nanowhiskers comprise at least one of: a high aspect ratio, are crystalline, or have a high thermal stability. In one aspect, the ionic liquid is 1-ethyl-3-methylimidazolium hydrogen sulfate. In another aspect, the raw chitinous biomass comprises at least one of: shrimp shell biomass, crab biomass, lobster biomass, squid pen, fly larvae, or a mixture thereof.

### BRIEF DESCRIPTION OF THE DRAWINGS

For a more complete understanding of the features and advantages of the present invention, reference is now made to the detailed description of the invention along with the accompanying figures and in which:

FIG. 1A shows the structure of chitin, FIG. 1B is a flowchart that shows the method of isolation of chitin of the prior art.

FIG. 2 is a High-Resolution Atomic Force Microscopy (AFM) Topography Image (Asylum Research MFP-3D™, 10 m scale) of chitin nanocrystals and nanowhiskers.

FIG. 3 is a High-Resolution Atomic Force Microscopy (AFM) Topography Image (Asylum Research MFP-3D™, 5 μm scale) of chitin nanocrystals and nanowhiskers.

FIG. 4 is a High-Resolution Atomic Force Microscopy (AFM) Topography Image (Asylum Research MFP-3D™, 2.5 μm scale) of chitin nanocrystals and nanowhiskers.

FIG. 5 shows a Fourier transform infrared spectra (FTIR) of shrimp shell biomass (red), commercial chitin (green) and chitin nanowhiskers (blue) of the present invention.

FIG. 6 shows a Fourier transform infrared spectra (FTIR) of crab and lobster mixed biomass (red), commercial chitin (green) and chitin nanowhiskers (blue) of the present invention.

FIG. 7 shows a Powder X-ray diffraction (PXRD) of shrimp shell biomass (red), commercial chitin (green) and chitin nanowhiskers (blue) of the present invention.

FIG. 8 shows a Powder X-ray diffraction (PXRD) of shrimp shell biomass (red), commercial chitin (green) and chitin nanowhiskers (blue) obtained from crab and lobster mixed biomass.

FIG. 9 shows a Transmission Electron Microscopy (TEM) image of nanowhiskers obtained using shrimp shell biomass in ionic liquid 1-butyl-3-methylimidazoulim hydrogen sulfate [C4mim][HSO4], Magnification ×30,000, under 300.0 kV.

FIG. 10 shows a Transmission Electron Microscopy (TEM) image of nanowhiskers obtained using shrimp shell biomass in ionic liquid 1-methylimidazoulim hydrogen sulfate [Hmim][HSO4], Magnification ×30,000, under 300.0 kV.

FIG. 11 shows a Transmission Electron Microscopy (TEM) image of nanowhiskers obtained using shrimp shell biomass in ionic liquid triethylammonium hydrogen sulfate [HTEA][HSO4], Magnification ×30,000, under 300.0 kV.

FIG. 12 shows a FTIR spectra of nanowhiskers obtained using shrimp shell biomass in ionic liquid triethylammonium hydrogen sulfate [HTEA][HSO4] (dark blue), 1-methylimidazoulim hydrogen sulfate [Hmim][HSO4] (red), and 1-butyl-3-methylimidazoulim hydrogen sulfate [C4mim][HSO4] (pink).

FIG. 13 shows a pXRD diffractograms of nanowhiskers obtained using shrimp shell biomass in ionic liquid triethylammonium hydrogen sulfate [HTEA][HSO4] (dark blue), 1-methylimidazoulim hydrogen sulfate [Hmim][HSO4] (red), and 1-butyl-3-methylimidazoulim hydrogen sulfate [C4mim][HSO4] (pink).

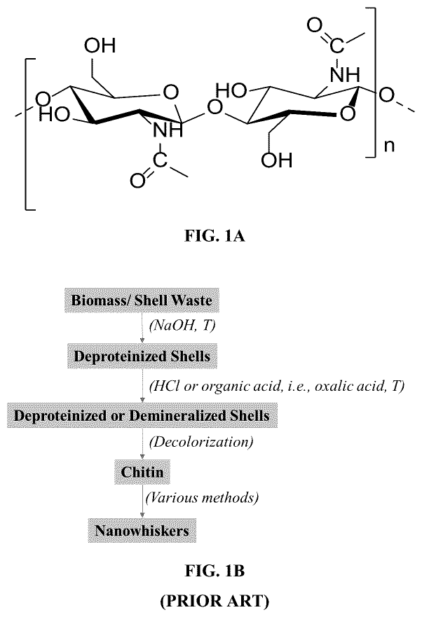

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Provided herein are methods related to chitin nanocrystals and nanowhiskers and particularly, but not exclusively, to methods for producing individual chitin nanocrystals and nanowhiskers from biomass, without prior isolation of raw chitin polymer using ionic liquid. The resulting chitin nanocrystals and nanowhiskers comprise a high aspect ratio, are highly crystalline, and of high thermal stability. The method also stands out due to a high, >70% yield based on amount of chitin present in biomass. In certain aspect, the present invention includes the isolation of purified chitin nanocrystals and nanowhiskers with a 30, 40, 50, 55, 60, 65, 70, 75, 79, 80 or greater percent yield. This patent establishes a profitable, sustainable process from, e.g., shrimp shell waste using a method that avoids corrosive or hazardous reagents and minimizes waste.

As used herein, the term “ionic liquids” refers to compounds that contain ionized species (i.e., cations and anions) that generally have a melting point below about 100° C. The anionic components in the mixture can be the same or different. Examples of ionic liquids are organic salts containing one or more cations that are typically ammonium, imidazolium, or pyridinium ions; although, many other types are known and disclosed herein. When referring to ionic liquid mixtures, these are crude ionic liquids. and can contain impurities such as solvent or water.

Properties of ionic liquids are high liquid range, non-volatility, non-flammability, high thermal stability. For a review of ionic liquids see, for example, Welton, Chem Rev., 99, 2071-2083, 1999. Ionic Liquids. Ionic liquids (ILs, organic salts with melting points below 100° C.¹²) are special class of solvents. IL technologies of biomass processing in general, and chitin processing in particular, have built an enormous quantity of technical reports (for recent reviews, please see: Silva et al.¹³ and Jaworska et al.¹⁴).

Ionic liquids can be impure and include solvent molecules in the amount for example, <10%, <5.0%, <4.0%, <3.0%, <2.0%, or <0.01%, however, these solvent molecules are not required to be present in order to form the ionic liquids. The solvent molecules might include water-soluble alcohols, ketones or aldehydes such as ethanol, methanol, 1- or 2-propanol, tert-butanol, acetone, methyl ethyl ketone, acetaldehyde, propionaldehyde, ethylene glycol, propylene glycol, dimethyl sulfoxide, dimethyl formamide, acetamide, hexamethyl phosphoramide, N-Methylmorpholine N-oxide (NMMO), the C₁-C₆ alkyl and alkoxy ethylene glycols and propylene glycols such as 2-methoxyethanol, 2-ethoxyethanol, 2-butoxyethanol, diethyleneglycol, and the like.

Chitin Nanowhiskers. Chitin nanocrystals and nanowhiskers are high performance nanomaterials that can be prepared from purified chitin. They are rod- or whisker-shaped particles that have dimensions selected from: 5-20 nm in width, 50-500 nm in length, and/or a high aspect ratio (10-100) depending on the source.¹⁰ In suspension, ChNCs tend to aggregate into irregular shapes with a wide particulate distribution ranging from 20 to 2,000 nm. They are different from chitin nanofibers (ChNFs) that have a diameter of about 5-20 nm but lengths in the micron scale. The particle size of ChNCs is one of the principal parameters that influences all properties of these nanoscale materials and determines their diffusivity, viscosity in a solution, uniformity, and chirality. Chitin nanowhiskers have been emerging as sustainable materials with unique properties like high aspect ratio, high modulus (200 GPa¹¹), stiffness, strength, non-toxicity, biodegradability, crystallinity, biocompatibility, high binding energy and liquid-crystalline behavior. As a rigid whisker-shaped nanomaterial, ChNWs are an ideal candidate for preparing nanocomposites as reinforcement materials for different polymeric matrices. ChNCs have a high potential in production of regenerative and bio-degradable materials in various technical fields.

Present Invention. Provided herein is a technology related to chitin nanocrystals and nanowhiskers and particularly, but not exclusively, to methods for producing individual chitin nanocrystals and nanowhiskers from biomass, without prior isolation of raw chitin polymer using ionic liquid. The resulting chitin nanocrystals and nanowhiskers comprise a high aspect ratio, are highly crystalline, and of high thermal stability. The method also stands out due to a high, 70% yield based on amount of chitin in biomass.

Biomass. As used herein, the term “chitinous biomass” means any source of chitin derived from marine or anthropod exoskeleton, squid pen, fungi, mushrooms, etc. Non-limiting examples of biomass include the shells of crustaceans: shrimp, crab, crawfish, prawns, lobster biomass, squid pen, fly larvae, or a mixture thereof. When the biomass is a chitin-containing biomass, the biomass can be any biomass either in a processed, derivatized, pure, or impure form. In a preferred aspect the biomass is a crustacean biomass.

Ionic Liquid. In this process, ILs act as a hydrolyzing agent. For the purpose, strongly “Brönsted Acidic Ionic Liquids” are suitable.³⁹ An acidic IL can be defined as a low melting ionic salt with acidic characteristics of Brönsted type. A “Bronsted acid” is an acidic compound capable of donating a proton to an appropriate base. ILs may contain one or more types of cations and one or more types of anions, which are described below. The acidic function(s) or group(s) can be either in the cation, anion, or both.

As used herein, the term “protic ionic liquid” describes an ionic liquid formed by the protonation of a base with a Bronsted acid to form a salt. In turn, a “Brönsted acid” is an acidic compound capable of donating a proton to an appropriate base.

Anion: An anion for a contemplated ionic liquid cation can be Bronsted-acidic anion.
the acidic IL with [HSO₄]⁻-anion;

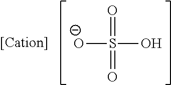

the acidic IL with [RSO₄]⁻-anion, where R=C1-C6 alkyl or a C1-C6 alkoxyalkyl group, or substituted alkyl/alkoxyalkyl

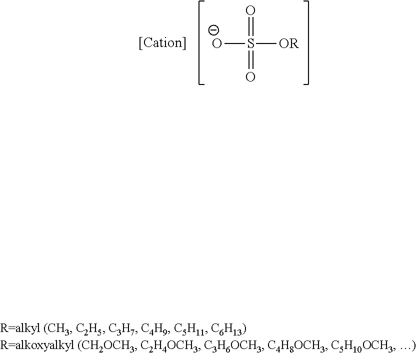

the acidic IL with [HSO₃]⁻-anion;

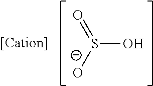

the acidic IL with [RSO₃]⁻-anion, where R=C1-C6 alkyl or a C1-C6 alkoxyalkyl group, or substituted alkyl/alkoxyalkyl

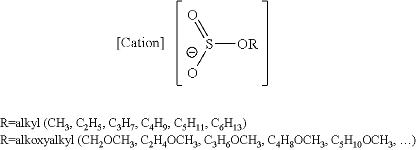

the acidic IL with [H₂PO₄]⁻-anion;

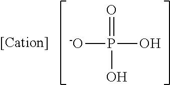

the acidic IL with [R₁R₂PO₄]⁻-anion, where R₁ and R₂=independently C1-C6 alkyl or a C1-C6 alkoxyalkyl group, or substituted alkyl/alkoxyalkyl

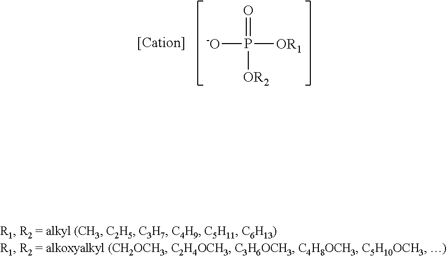

the acidic IL with [NO_{3]}⁻-anion;

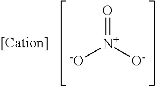

### Cations

Imidazolium or substituted imidazolium

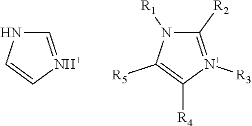

Ammonium or substituted ammonium

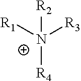

Pyridinium or substituted pyridinium

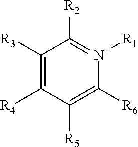

Brönsted Acidic Ionic Liquids with Acidic Hydrogens on a Functional Group
alkane sulfonic acid group —SO₃H is covalently tethered to the IL cation
   Examples (can be any cation mentioned below)

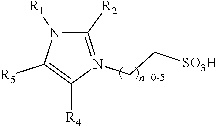

Protic Acidic Ionic Liquids with Acidic Hydrogens on Cation and Anion
Combinations of anything from above

### Example 1

Shrimp shells were ground, sieved to <150 μm, and dried in the oven at 50° C. overnight. Ionic liquid 1-butyl-3-methylimidazoulim hydrogen sulfate [C₄mim][HSO₄] (48.5 g) was added to 1.5 g chitinous biomass, the obtained paste thoroughly mixed, capped, wrapped with parafilm and left for 48 h. After 48 hours, water was added to the reactions (16.7 mL). When water was added, the reaction produced large amount of foam. Reaction was subjected to 110° C. heating in oil bath, for another 48 hours, then quenched with 50 mL water. The solution was poured into beaker, more water added (50 mL water), resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 6 cycles). The resulting suspension was ultrasonicated with 30 second cycles, for overall 10 min. To quantify the amount of ChNCs, half of the suspension was freeze-dried. Yield of chitin-nanocrystals and nanowhiskers 79% was obtained. Table 1 shows the results.

TABLE 1

| | | | | | | Aspect | | Aspect |
|---|---|---|---|---|---|---|---|---|
| | | | | | | Ratio | | Ratio |
| | | | Dimensions | | Sample | (L/W) | | Sample |
| Sample | Yield | Size | (mean) | Deviation | Size | Mean | Deviation | Size |
| Shrimp Shells/ | 75 | Length | 561 | 157 | 36 | 55.49 | 22.10 | 36 |
| [Bmim][HSO₄] | | Width | 10.0 | 3.6 | 90 | | | |

### Example 2

Crab and lobster shells (mixture) were ground, sieved to <150 μm, and dried in the oven at 50° C. overnight. Ionic liquid 1-butyl-3-methylimidazoulim hydrogen sulfate [C₄mim][HSO₄] (48 g) was added to 2 g chitinous biomass, the obtained paste thoroughly mixed, capped, wrapped with parafilm and left for 48 h. After 48 h, water was added to the reactions (16 mL). When water was added, the reaction produced large amount of foam. The reaction was subjected to 110° C. heating in oil bath, for another 48 h, then quenched with 50 mL of water. The solution was poured into beaker, more water added (50 mL water), the resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 6 cycles). The resulting suspension was ultrasonicated with 30 s cycles, for overall 10 min. To quantify amount of ChNCs, half of the suspension was freeze-dried. Yield of chitin-nanocrystals and nanowhiskers 81% was obtained. Table 2 shows the results.

TABLE 2

| | | | | | | Aspect | | Aspect |
|---|---|---|---|---|---|---|---|---|
| | | | | | | Ratio | | Ratio |
| | | | Dimensions | | Sample | (L/W) | | Sample |
| Sample | Yield | Size | (mean) | Deviation | Size | Mean | Deviation | Size |
| Crab Shells/ | 81 | Length | 612 | 150 | 30 | 47.07 | 20.10 | 30 |
| [Bmim][HSO₄] | | Width | 13.0 | 3.1 | 93 | | | |

### Example 3

Dried white mushrooms were ground, sieved to <150 μm, and dried in the oven at 50° C. overnight. Ionic liquid 1-butyl-3-methylimidazoulim hydrogen sulfate [C₄mim][HSO₄] (48 g) was added to 2 g mushroom biomass, the obtained paste thoroughly mixed, capped, wrapped with parafilm and left for 24 h. After 24 h, water was added to the reactions (14 mL). No foam was formed. The reaction was subjected to 100° C. heating in oil bath, for 24 h, then quenched with 40 mL of water. The solution was poured into beaker, more water added (50 mL water), the resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 6 cycles). The resulting suspension was ultrasonicated with 30 s cycles, for overall 10 min. The suspension was freeze-dried.

### Example 4

Shrimp shells were ground, sieved to <150 μm, and dried in the oven at 50° C. overnight. Ionic liquid 1-methylimidazoulim hydrogen sulfate [Hmim][HSO₄] (24.25 g) was added to 0.751 g chitinous biomass, the obtained paste thoroughly mixed, capped, wrapped with parafilm and left for 48 h. After 48 hours, water was added to the reactions (8 mL). When water was added, the reaction produced large amount of foam. Reaction was subjected to 110° C. heating in [0088] oil bath, for another 48 hours, then quenched with 50 mL water. The solution was poured into beaker, more water added (50 mL water), resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 10 cycles). The resulting suspension was ultrasonicated with 30 second cycles, for overall 10 min. To quantify the amount of ChNCs, half of the suspension was freeze-dried. Yield of chitin-nanocrystals and nanowhiskers 77% was obtained in Trial 1, and 83% in Trial 2. Table 3 shows the results.

TABLE 3

| | | | | | | Aspect | | Aspect |
|---|---|---|---|---|---|---|---|---|
| | | | | | | Ratio | Aspect | Ratio |
| | | | Dimensions | Dimensions | Sample | (L/W) | Ratio | Sample |
| Sample | Yield | Size | (mean) | STD. | Size | Mean | STD | Size |
| Shrimp Shells/ | 77-83 | Length | 576 | 168 | 21 | 55.16 | 28.09 | 21 |
| [Hmim][HSO₄] | | Width | 11.7 | 2.9 | 62 | | | |

### Example 5

Shrimp shells were ground, sieved to <150 μm, and dried in the oven at 50° C. overnight. Ionic liquid triethylammonium hydrogen sulfate [HTEA][HSO₄] (24.5 g) was added to 0.748 g chitinous biomass, the obtained paste thoroughly mixed, capped, wrapped with parafilm and left for 48 h. After 48 hours, water was added to the reactions (8 mL). When water was added, the reaction produced large amount of foam. Reaction was subjected to 110° C. heating in [0092] oil bath, for another 48 hours, then quenched with 50 mL water. The solution was poured into beaker, more water added (50 mL water), resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 8 cycles).

The resulting suspension was ultrasonicated with 30 second cycles, for overall 10 min. To quantify the amount of ChNCs, half of the suspension was freeze-dried. Yield of chitin-nanocrystals and nanowhiskers 79% was obtained. Table 4 shows the results.

TABLE 4

| | | | | | | Aspect | | Aspect |
|---|---|---|---|---|---|---|---|---|
| | | | | | | Ratio | Aspect | Ratio |
| | | | Dimensions | Dimensions | Sample | (L/W) | Ratio | Sample |
| Sample | Yield | Size | (mean) | STD. | Size | Mean | STD | Size |
| Biomass/ | 79 | Length | 612 | 198 | 41 | 34.80 | 15.8 | 41 |
| [HTEA][HSO₄] | | Width | 17.3 | 3.9 | 127 | | | |

### Example 6

Squid pen were dried in the oven at 50° C. overnight, and ground using coffee grinder. Ionic liquid 1-butyl-3-methylimidazoulim hydrogen sulfate [C₄mim][HSO₄] (48.5 g) was added to 1.5 g chitinous biomass, the obtained paste thoroughly mixed, capped, wrapped with parafilm and left for 48 h. After 48 hours, water was added to the reactions (16.7 mL). When water was added, the reaction produced large amount of foam. Reaction was subjected to 110° C. heating in oil bath, for another 48 hours, then quenched with 50 mL water. The solution was poured into beaker, more water added (50 mL water), resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 6 cycles).

The resulting suspension was ultrasonicated with 30 second cycles, for overall 10 min. To quantify the amount of ChNCs, half of the suspension was freeze-dried. Yield of chitin-nanocrystals and nanowhiskers 82% was obtained.

### Example 7

Fly larvae was dried in the oven at 50° C. overnight, and ground using coffee grinder. Ionic liquid 1-butyl-3-methylimidazoulim hydrogen sulfate [C₄mim][HSO₄] (48.5 g) was added to 1.5 g chitinous biomass, the obtained paste thoroughly mixed, capped, wrapped with parafilm and left for 48 h. After 48 hours, water was added to the reactions (16.7 mL). When water was added, the reaction produced large amount of foam. Reaction was subjected to 110° C. heating in oil bath, for another 48 hours, then quenched with 50 mL water. The solution was poured into beaker, more water added (50 mL water), resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 6 cycles).

The resulting suspension was ultrasonicated with 30 second cycles, for overall 10 min. To quantify the amount of ChNCs, half of the suspension was freeze-dried. Yield of chitin-nanocrystals and nanowhiskers 82% was obtained.

### Example 8

Chitosan powder were dried in the oven at 50° C. overnight, and ground using coffee grinder. Ionic liquid 1-butyl-3-methylimidazoulim hydrogen sulfate [C₄mim][HSO₄] (48.5 g) was added to 1.5 g chitinous biomass, the obtained paste thoroughly mixed, capped, wrapped with parafilm and left for 48 h. After 48 hours, water was added to the reactions (16.7 mL). When water was added, the reaction produced large amount of foam. Reaction was subjected to 110° C. heating inoil bath, for another 48 hours, then quenched with 50 mL water. The solution was poured into beaker, more water added (50 mL water), resulting suspension was mixed, transferred into test tubes, and centrifuged (Eppendorf 5430 R, rotor CE 11017, 7830 rpm). The precipitate was repeatedly washed through several water addition-centrifugation cycles (water decanted, 2×45 mL fresh water added, particles dispersed and suspension centrifuged) until pH 6-7 (total 6 cycles).

The resulting suspension was ultrasonicated with 30 second cycles, for overall 10 min. To quantify the amount of ChNCs, half of the suspension was freeze-dried. Yield of chitosan-nanocrystals and nanowhiskers 82% was obtained.

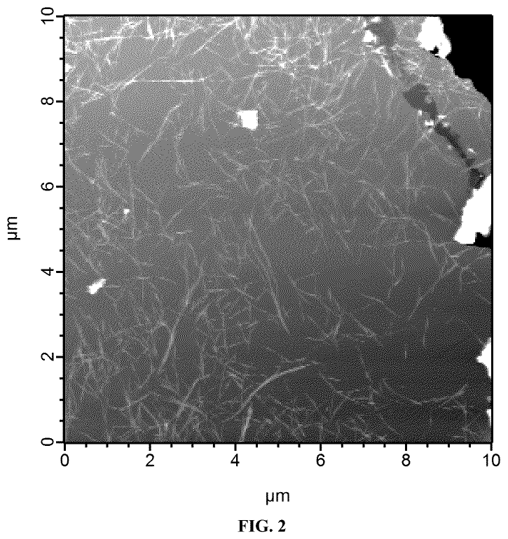

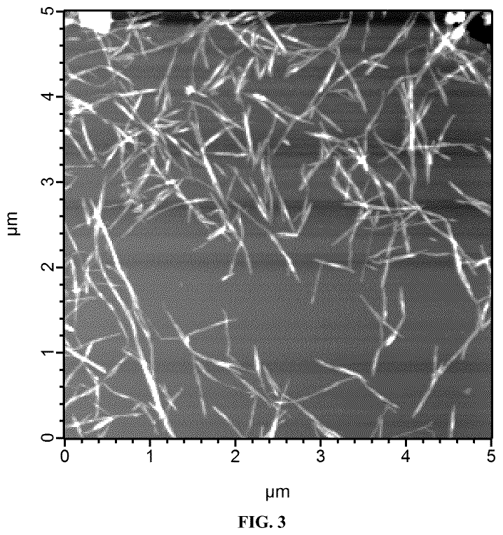

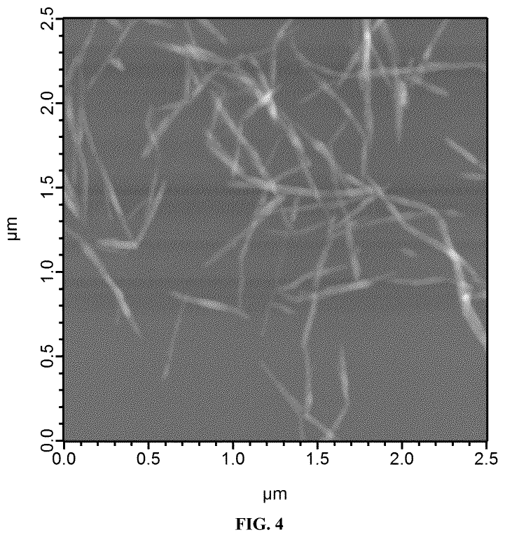

FIG. 2 is a High-Resolution Atomic Force Microscopy (AFM) Topography Image (Asylum Research MFP-3D™, 10 m scale) of chitin nanocrystals and nanowhiskers. FIG. 3 is a High-Resolution Atomic Force Microscopy (AFM) Topography Image (Asylum Research MFP-3D™, 5 μm scale) of chitin nanocrystals and nanowhiskers obtained from shrimp shell biomass. FIG. 4 is a High-Resolution Atomic Force Microscopy (AFM) Topography Image (Asylum Research MFP-3D™, 2.5 μm scale) of chitin nanocrystals and nanowhiskers obtained from shrimp shell biomass.

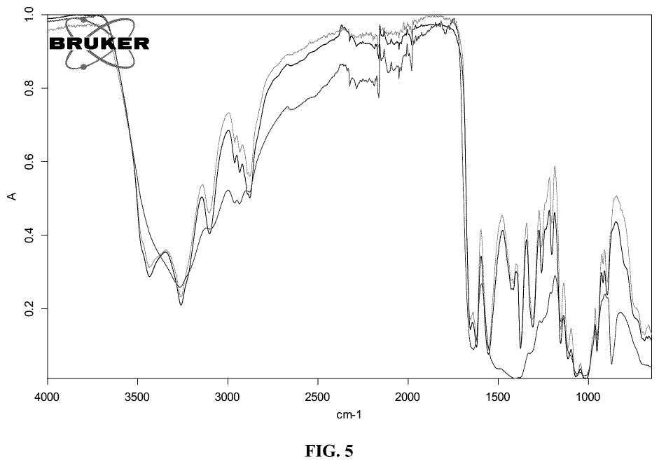

FIG. 5 shows a Fourier transform infrared spectra (FTIR) of shrimp shell biomass (red), commercial chitin (green) and chitin nanowhiskers (blue) obtained from shrimp shell biomass.

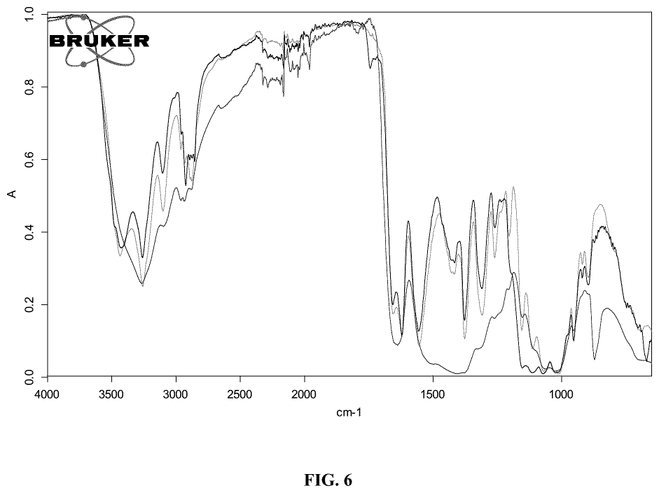

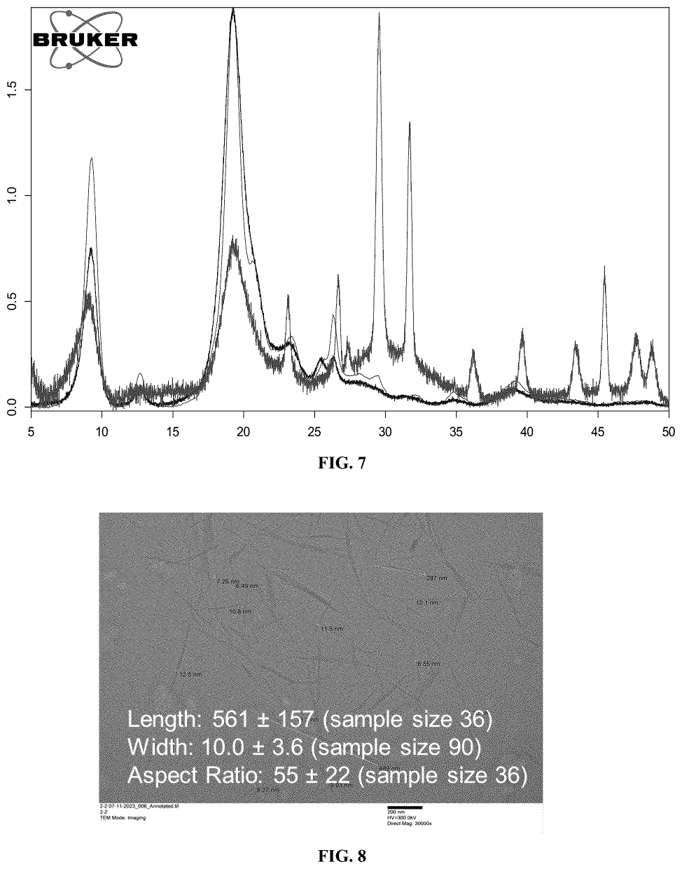

FIG. 6 shows a Fourier transform infrared spectra (FTIR) of crab and lobster mixed biomass (red), commercial chitin (green) and chitin nanowhiskers (blue) obtained from crab and lobster mixed biomass. FIG. 7 shows a Powder X-ray diffraction (PXRD) of shrimp shell biomass (red), commercial chitin (green) and chitin nanowhiskers (blue) obtained from shrimp shell biomass. FIG. 8 shows a Powder X-ray diffraction (PXRD) of shrimp shell biomass (red), commercial chitin (green) and chitin nanowhiskers (blue) obtained from crab and lobster mixed biomass.

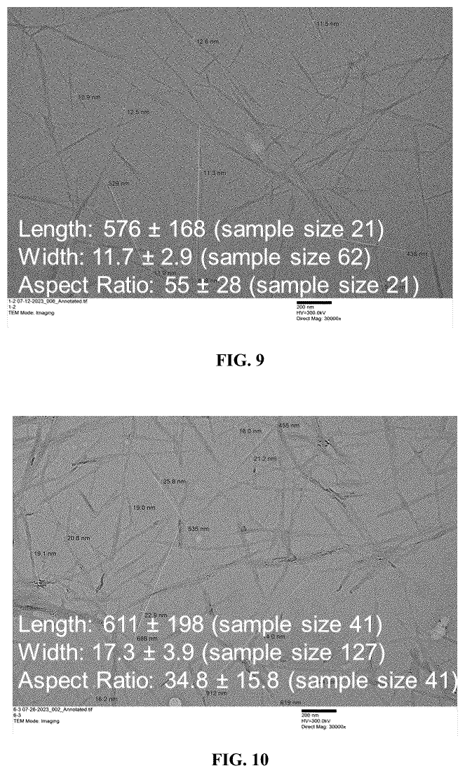

FIG. 9 shows a Transmission Electron Microscopy (TEM) image of nanowhiskers obtained using shrimp shell biomass in ionic liquid 1-butyl-3-methylimidazoulim hydrogen sulfate [C4mim][HSO4], Magnification ×30,000, under 300.0 kV.

FIG. 10 shows a Transmission Electron Microscopy (TEM) image of nanowhiskers obtained using shrimp shell biomass in ionic liquid 1-methylimidazoulim hydrogen sulfate [Hmim][HSO4], Magnification ×30,000, under 300.0 kV.

FIG. 11 shows a Transmission Electron Microscopy (TEM) image of nanowhiskers obtained using shrimp shell biomass in ionic liquid triethylammonium hydrogen sulfate [HTEA][HSO4], Magnification ×30,000, under 300.0 kV.

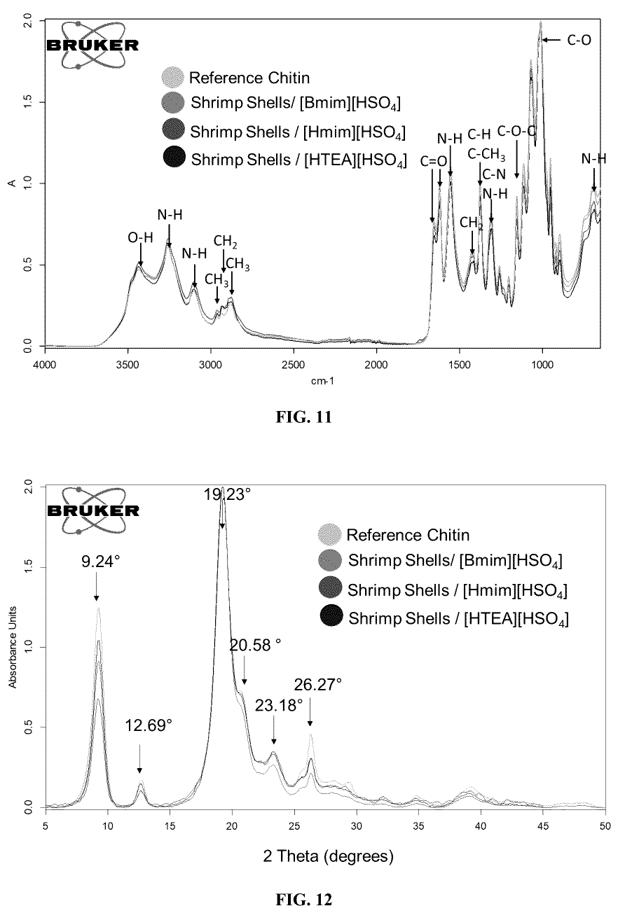

FIG. 12 shows a FTIR spectra of nanowhiskers obtained using shrimp shell biomass in ionic liquid triethylammonium hydrogen sulfate [HTEA][HSO4] (dark blue), 1-methylimidazoulim hydrogen sulfate [Hmim][HSO4] (red), and 1-butyl-3-methylimidazoulim hydrogen sulfate [C4mim][HSO4] (pink).

FIG. 13 shows a pXRD diffractograms of nanowhiskers obtained using shrimp shell biomass in ionic liquid triethylammonium hydrogen sulfate [HTEA][HSO4] (dark blue), 1-methylimidazoulim hydrogen sulfate [Hmim][HSO4] (red), and 1-butyl-3-methylimidazoulim hydrogen sulfate [C4mim][HSO4] (pink).

Thus, the present invention allows formation of chitin nanowhiskers directly from biomass, allows making nanowhiskers in a single step, eliminates use of hydrochloric acid from chemical synthesis, and/or eliminates hazardous solvents from chemical synthesis. The method taught herein does not require prior isolation of chitin from crustacean biomass, and is a “green” method that does not use hazardous solvents.

Further, the present invention obtains chitin nanowhiskers without the use of hydrolysis with using strong acids (e.g., 2.5-4 N hydrochloric acid), TEMPO-mediated oxidation; ultrasonication; and/or mechanochemistry. One of more of these methods causes mechanical damage to the chitin nanowhiskers, has a reduced yield, and requires the use of more than one step for the isolation of the chitin nanowhiskers.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/of” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically, and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

1. Nawawi, W. M. F. B. W., Jones, M., Murphy, R. J. Lee, K.-Y., Kontturi, E., Bismarck, A. Nanomaterials Derived from Fungal Sources—Is It the New Hype?Biomacromolecules 2020, 21, 30-55.
2. Elieh-Ali-Komi, D., Hamblin, M. R. Chitin and Chitosan: Production and Application of Versatile Biomedical Nanomaterials. Int. J. Adv. Res. 2016, 4(3), 411-427.
3. Jiménez-Gómez, C. P., Cecilia, J. A. Chitosan: A Natural Biopolymer with a Wide and Varied Range of Applications. Molecules (Basel, Switzerland) 2020, 25(17), 3981.
4. Azuma, K., Izumi, R., Osaki, T., Ifuku S., Morimoto, M., Saimoto, H., Minami, S., Okamoto, Y. Chitin, chitosan, and its derivatives for wound healing: old and new materials. J. Funct. Biomater. 2015, 6(1), 104-42.
5. Ogawa, Y., Lee, C. M., Nishiyama, Y., Kim, S. H. Absence of Sum Frequency Generation in Support of Orthorhombic Symmetry of α-Chitin. Macromolecules 2016, 49, 7025-7031.
6. Sattler, K. D. Handbook of Nanophysics: Nanoparticles and Quantum Dots.
7. Jang, M.-K., Kong, B.-G., Jeong, Y.-J., Lee, C. H. and Nah, J.-W. (2004), Physicochemical characterization of α-chitin, 0-chitin, and γ-chitin separated from natural resources. J. Polym. Sci. A Polym. Chem. 2004, 42, 3423-3432.
8. Raabe, D., Sachs, C., Romanoet, P. The crustacean exoskeleton as an example of a structurally and mechanically graded biological nanocomposite material. Acta Materialia 2005, 53, 4281-4292.
9. Younes, I., Rinaudo, M. Chitin and chitosan preparation from marine sources. Structure, properties and applications. Marine Drugs 2015, 13(3), 1133-1174.
10. Aranaz, I., Mengibar, M., Harris, R., Panos, I., Miralles, B., Acosta, N., Galed, G., Heras, A. Functional characterization of chitin and chitosan. Curr. Chem. Biol. 2009, 3, 203-230.
11. Li, J., Revol, J., Marchessault, R. H. Effect of degree of deacetylation of chitin on the properties of chitin crystallites. J. Appl. Polym. Sci. 1997, 65, 373-380.
12. Hayes, R., Warr G. G., Atkin, R. Structure and Nanostructure in Ionic Liquids. Chemical Rev. 2015, 115, 6357-6426.
13. Silva, S. S., Mano J. F., Reis, R. L. Ionic liquids in the processing and chemical modification of chitin and chitosan for biomedical applications. Green Chem. 2017, 19, 1208-1220.
14. Jaworska, M., Koźlecki T., Górak, A. Review of the application of ionic liquids as solvents for chitin. J. Polymer Eng. 2012, 32, 67-69.
15. Shamshina, J. L. Chitin in Ionic Liquids: Historical Insights on the Polymer's Dissolution and Isolation. A Review. Green. Chem. 2019, 21, 3974-3993.
16. Shamshina, J. L., Berton, P., Rogers, R. ACS Sustainable Chem. & Eng., 2019.
17. Roy, J. C., Salaün, F., Giraud, S., Ferri, A., Chen G., Guan, J. in Solubility of Polysaccharides, ed. Z. Xu, InTech, Vienna, Austria, 2017, pp. 109-127.
18. Pillai, C. K. S., Paul, W., Sharma, C. P. Progr. Polym. Sci., 2009, 34, 641-678.
19. Shamshina, J. L., Gurau, G., Block, L. E., Hansen, L. K., Dingee, C., Walters A., Rogers, R. D. J. Mater. Chem. B, 2014, 2, 3924-3936. DOI: 10.1039/C4TB00329B.
20. J. L. Shamshina, O. Zavgorodnya and R. D. Rogers, in Green Electrospinning, ed. N Horzum, M. M. Demir, R. Munoz-Espi and D. Crespy, DeGruyter, Berlin, 2018, in press.
21. J. L. Shamshina, O. Zavgorodnya, G. Gurau and R. D. Rogers, U.S. Provisional Application 62,476,013, 2017.
22. J. L. Shamshina, O. Zavgorodnya, J. R. Bonner, G. Gurau, T. Di Nardo and R. D. Rogers, ChemSusChem. 2017, 1, 106-111, DOI: 10.1002/cssc.201601372.
23. C. King, J. L. Shamshina, O. Zavgorodnya, T. Cutfield, L. E. Block and R. D. Rogers, ACS Sustainable Chem. Eng. 2017, 5, 11660-11667. DOI: 10.1021/acssuschemeng.7b03053.
24. Kadokawa, J.-i., Takegawa, A., Mine, S., Prasad, K. Preparation of chitin nanowhiskers using an ionic liquid and their composite materials with poly(vinyl alcohol). Carbohydr. Polym. 2011, 84(4), 1408-1412.
25. dx.doi.org/10.1021/bm201564a|Biomacromolecules 2012, 13, 1-11
26. Mincea, M., Negrulescu, A., Ostafe, V. Preparation, modification, and applications of chitin nanowhiskers: A review. Rev. Adv. Mat. Sci., 2012, 30, 225-242.
27. Morin, A., Dufresne, A. Nanocomposites of Chitin Whiskers from Riftia Tubes and Poly(caprolactone). Macromolecules 2002, 35, 2190-2199.
28. Midhun Dominic C. D., Rani, J., Begum, P. M., Raghunandanan, A., Vackkachan, N. T., Padmanabhan, D., Formela, K. Chitin nanowhiskers from shrimp shell waste as green filler in acrylonitrile-butadiene rubber: Processing and performance properties. Carbohydr. Polym. 2020, 116505.
29. Druzian, S. P., Zanatta, N. P., Côrtes, L. N., Streit, A. F. M., Dotto, G. L. Preparation of chitin nanowhiskers and its application for crystal violet dye removal from wastewaters. Env. Sci. Pollution Res. Int. 2019, 26(28), 28548-2855.
30. Revol, J.-F., Marchessault, R. H. In vitro chiral nematic ordering of chitin crystallites. Int. J. Biol. Macromol. 1993, 15, 329-335.
31. Gopalan Nair, K. and Dufresne, A. Crab shell chitin whisker reinforced natural rubber nanocomposites. 1. Processing and swelling behaviour. Biomacromolecules 2003, 4, 657 665.
32. Gopalan Nair, K. and Dufresne, A. Crab shell chitin whisker reinforced natural rubber nanocomposites. 2. Mechanical behaviour. Biomacromolecules 2003, 4, 666-674;
33. Gopalan Nair, K., Dufresne, A., Gandini, A. and Belgacem, M. N. Crab shell chitin whisker reinforced natural rubber nanocomposites. 3. Effect of chemical modification of chitin whiskers. Biomacromolecules 2003, 4, 1835-1842.
34. Nge, T. T., Hori, N., Takemura, A. and Ono, H. Phase behavior of liquid crystalline chitin/acrylic acid liquid mixture. Langmuir 2003, 19, 1390-1395;
35. Lu, Y., Weng, L. and Zhang, L. Morphology and properties of soy protein isolate thermo-plastics reinforced with chitin whiskers. Biomacromolecules 2004, 5, 1046-1051;
36. Tzoumaki, M. V., Moschakis, T. and Biliaderis, C. G. Metastability of nematic gels made of aqueous chitin nanocrystal dispersions. Biomacromolecules 2010, 11, 175-181.
37. Feng, L., Zhou, Z., Dufresne, A., Huang, J., Wei, M. and An, L. Structure and properties of new thermoforming bionanocomposites based on chitin whisker-graft-polycaprolactone. J. Appl. Polym. Sci. 2009, 112, 2830-2837.
38. Hariraksapitak, P. and Supaphol, P. Preparation and properties of α-chitin-whisker-reinforced hyaluronangelatin nanocomposite scaffolds. J. Appl. Polym. Sci. 2010, 117, 3406-3418;
39. Morin, A. and Dufresne, A. Nanocomposites of chitin whiskers from Riftia tubes and poly(caprolactone). Macromolecules 2002, 35, 2190-2199.
40. Sriupayo, J., Supaphol, P., Blackwell, J. and Rujiravanit, R. Preparation and characterization of α-chitin whisker-reinforced poly(vinyl alcohol) nanocomposite films with or without heat treatment. Polymer 2005, 46, 5637-5644,
41. Goodrich, J. D. and Winter, W. T. α-chitin nanocrystals prepared from shrimp shell sand their specific surface area measurement. Biomacromolecules 2007, 8, 252-257,
42. Wongpanit, P., Sanchavanakit, N., Pavasant, P., Bunaprasert, T., Tabata, Y. and Rujiravanit, R. Preparation and characterization of chitin whisker-reinforced silk fibroin nanocomposite sponges. Eur. Polym. J. 2007, 43, 4123-4135,
43. Watthanaphanit, A., Supaphol, P., Tamura, H., Tokura, S. and Rujiravanit, R. Fabrication, structure and properties of chitin whisker-reinforced alginate nanocomposite fibers. J. Appl. Polym. Sci. 2008, 110, 890-899,
44. Watthanaphanit, A., Supaphol, P., Tamura, H., Tokura, S. and Rujiravanit, R. Wet-spun alginate/chitosan whiskers nanocomposite fibers: Preparation, characterization and release characteristic of the whiskers. Carbohydr. Polym. 2010, 79, 738-746,
45. Phongying, S., Aiba, S. and Chirachanchai, S. Direct chitosan nanoscaffold formation via chitin whiskers. Polymer 2007, 48, 393-400,
46. Junkasem, J., Rujiravanit, R., Grady, B. P. and Supaphol, P. X-ray diffraction and dynamic mechanical analyses of α-chitin whisker-reinforced poly(vinyl alcohol) nanocomposite nanofibers. Polym. Int. 2010, 59, 85-91,
47. Paillet, M. and Dufresne, A. Chitin whisker reinforced thermoplastic nanocomposites. Macromolecules 2001, 34, 6527-6530.
48. Yamamoto, Y., Nishimura, T., Saito, T., Kato, T. CaCO3/chitin-whisker hybrids: formation of CaCO3 crystals in chitin-based liquid-crystalline suspension. Polymer J. 2010, 42, 583-586.
49. Fan, Y., Saito, T., Isogai, A. Preparation of chitin nanofibers from squid pen beta-chitin by simple mechanical treatment under acid conditions. Biomacromolecules 2008, 9, 1919-1923.
50. Fan, Y., Saito, T., Isogai, A. Chitin nanocrystals prepared by TEMPO-mediated oxidation of alpha-chitin. Biomacromolecules 2008, 9, 192-198.
51. Zhang, K., Liu, P. Method for Isolating Cellulose- or Chitin-Nanocrystals by Means of Periodate Oxidation. U.S. Patent Application 20210108003, Dec. 21, 2020.
52. Liu, P., Liu, H., Schafer, T., Gutmann, T., Gibhardt, H., Qi, H., Tian, L., Zhang, X. C., Buntkowsky, G., Zhang, K. Unexpected selective alkaline periodate oxidation of chitin for the isolation of chitin nanocrystals. Green Chem. 2021, 23, 745-751.
53. Oun, A. A., Rhim, J.-W. Effect of oxidized chitin nanocrystals isolated by ammonium persulfate method on the properties of carboxymethyl cellulose-based films. Carbohydr. Polymers 2017, 175, 712-720.
54. Hong, S., Yuan, Y., Zhang, K., Lian, H., Liimatainen, H. Efficient Hydrolysis of Chitin in a Deep Eutectic Solvent Synergism for Production of Chitin Nanocrystals. Nanomaterials (Basel, Switzerland) 2020, 10(5), 869.
55. Amarasekara, A. S. Acidic Ionic Liquids. Chem. Rev. 2016, 116, 6133-6183.
56. Bai, L.; Liu, L.; Esquivel, M.; Tardy, B. L.; Huan, S.; Niu, X.; Liu, S.; Yang, G.; Fan, Y.; Rojas, O. J. Nanochitin: Chemistry, Structure, Assembly, and Applications. Chem. Rev. 2022, 122, 11604-11674. doi.org/10.1021/acs.chemrev.2c00125.
57. Lee, S.; Hao, L. T.; Park, J.; Oh, D. X.; Hwang, D. S. Nanochitin and Nanochitosan: Chitin Nanostructure Engineering with Multiscale Properties for Biomedical and Environmental Applications. Adv. Mater. 2023, 35, 2203325. doi.org/10.1002/adma.202203325.
58. Sanchez, C.; Boissiere, C.; Cassaignon, S.; Chaneac, C.; Durupthy, O.; Faustini, M.; Grosso, D.; Laberty-Robert, C.; Nicole, L.; Portehault, D.; Ribot, F.; Rozes, L.; Sassoye, C. Molecular Engineering of Functional Inorganic and Hybrid Materials. Chem. Mater. 2014, 26, 221-238. doi.org/10.1021/cm402528b.
59. Serventi, L.; He, Q.; Huang, J.; Mani, A.; Subhash, A. J. Advances in the preparations and applications of nanochitins. Food Hydrocolloids for Health 2021, 100036. doi.org/10.1016/j.fhfh.2021.100036.
60. Dominic, C. D. M.; Joseph, R.; Sabura Begum, P. M.; Raghunandanan, A.; Vackkachan, N. T.; Padmanabhan, D.; Formela, K. Chitin Nanowhiskers from Shrimp Shell Waste as Green Filler in Acrylonitrile-Butadiene Rubber: Processing and Performance Properties. Carbohydr. Polym. 2020, 245. doi.org/10.1016/j.carbpol.2020.116505.
61. Liu, Y.; Liu, M.; Yang, S.; Luo, B.; Zhou, C. Liquid Crystalline Behaviors of Chitin Nanocrystals and Their Reinforcing Effect on Natural Rubber. ACS Sustain. Chem. Eng. 2018, 6 (1), 325-336. doi.org/10.1021/acssuschemeng.7b02586.
62. Chi-Yan Li, S.; Sun, Y. C.; Guan, Q.; Naguib, H. Effects of Chitin Nanowhiskers on the Thermal, Barrier, Mechanical, and Rheological Properties of Polypropylene Nanocomposites. RSC Adv. 2016, 6 (76), 72086-72095. doi.org/10.1039/c6ra11623j.
63. Wang, M.; Xue, H.; Feng, Z.; Cheng, B.; Yang, H. Increase of Tensile Strength and Toughness of Bio-Based Diglycidyl Ether of Bisphenol A with Chitin Nanowhiskers. PLoS One 2017, 12 (6), 1-12. doi.org/10.1371/journal.pone.0177673.
64. Zhong, T.; Jian, G.; Chen, Z.; Wolcott, M.; Nassiri, S.; Fernandez, C. A. Interfacial Interactions and Reinforcing Mechanisms of Cellulose and Chitin Nanomaterials and Starch Derivatives for Cement and Concrete Strength and Durability Enhancement: A Review. Nanotechnol. Rev. 2022, 11 (1), 2673-2713. doi.org/10.1515/ntrev-2022-0149.
65. Haider, M. M.; Jian, G.; Zhong, T.; Li, H.; Fernandez, C. A.; Fifield, L. S.; Wolcott, M.; Nassiri, S. Insights into Setting Time, Rheological and Mechanical Properties of Chitin Nanocrystals- and Chitin Nanofibers-Cement Paste. Cem. Concr. Compos. 2022, 132, 104623. doi.org/10.1016/j.cemconcomp.2022.104623.
66. Mushi, N. E.; Utsel, S.; Berglund, L. A. Nanostructured Biocomposite Films of High Toughness Based on Native Chitin Nanofibers and Chitosan. Front. Chem. 2014, 2 (NOV), 1-11. doi.org/10.3389/fchem.2014.00099.
67. Hashiguchi, T.; Yamamoto, K.; Kadokawa, J.-i. Fabrication of highly flexible nanochitin film and its composite film with anionic polysaccharide. Carbohydr. Polym. 2021, 270, 118369. doi.org/10.1016/j.carbpol.2021.118369.
68. Konar, M. N.; Latha, S.; Chadha, U.; Bhardwaj, P.; Eticha, T. K. Chitosan Superabsorbent Biopolymers in Sanitary and Hygiene Applications. Int. J. Polym. Sci. 2023, doi.org/10.1155/2023/4717905.
69. Fernandes, S. C. M.; Aguirre, G. Biopolymer Micro/Nanogel Particles as Smart Drug Delivery and Theranostic Systems. Pharmaceutics 2023, 15(8), 2060. doi.org/10.3390/pharmaceutics15082060.
70. Olza, S.; Salaberria, A. M.; Alonso-Varona, A.; Samanta, A.; Fernandes, S. C. M. The Role of Nanochitin in Biologically-Active Matrices for Tissue Engineering—Where Do We Stand? J. Mat. Chem. B. 2023, 11, 5630-5649. doi.org/10.1039/D3TB00583F.
71. Zubillaga V.; Salaberria A. M.; Palomares T.; Alonso-Varona A.; Kootala S.; Labidi J.; Fernandes S. C. M. Chitin Nanoforms Provide Mechanical and Topological Cues to Support Growth of Human Adipose Stem Cells in Chitosan Matrices. Biomacromolecules 2018, 19, 3000-3012. doi.org/10.1021/acs.biomac.8b00570.
72. Suneetha, M.; Kim, H.; Han, S. S. Doxorubicin-Loaded Fungal-Carboxymethyl Chitosan Functionalized Polydopamine Nanoparticles for Photothermal Cancer Therapy. Pharmaceutics 2023, 15, 1281. doi.org/10.3390/pharmaceutics1504l281.
73. Schatz S.; Reisbeck F.; Schmitt, A. C.; Dimde, M.; Quaas, E.; Achazi, K.; Haag R. Tunable Polyglycerol-Based Redox-Responsive Nanogels for Efficient Cytochrome c Delivery. Pharmaceutics 2021, 13, 1276. doi.org/10.3390/pharmaceutics13081276.
74. Andre, R. S.; dos Santos, D. M.; Mercante, L. A.; Facure, M. H. M.; Campana-Filho, S. P.; Mattoso, L. H. C.; Correa, D. S. Nanochitin-based composite films as a disposable ethanol sensor. J. Environ. Chem. Eng. 2020, 8, 104163. doi.org/10.1016/j.jece.2020.104163.
75. Heidarian, P.; Gharaie, S.; Yousefi, H.; Paulino, M.; Kaynak, A.; Varley, R.; Kouzani, A. Z. A. 3D printable dynamic nanocellulose/nanochitin self-healing hydrogel and soft strain sensor. Carbohydr. Polym. 2022, 291, 119545. doi.org/10.1016/j.carbpol.2022.119545.
76. Dasan, Y. K.; Bhat, A. H.; Khan, I. Chapter 1. Nanocellulose and nanochitin for water remediation by adsorption of heavy metals. In: Nanomaterials for Water Remediation. doi.org/10.1515/9783110650600-001.
77. CORDIS: Functional membranes/filters with anti/low-fouling surfaces for water purification through selective adsorption on biobased nanocrystals and fibrils. Available at: cordis.europa.eu/project/id/280519 (accessed Feb. 12, 2024).
78. Lee, S.; Hao, L. T.; Park, J.; Oh, D. X.; Hwang, D. S. Nanochitin and Nanochitosan: Chitin Nanostructure Engineering with Multiscale Properties for Biomedical and Environmental Applications. Adv. Mater. 2023, 35(4), e2203325. doi.org/10.1002/adma.202203325.
79. He, Y.; Lin, X.; Feng, Y.; Luo, B.; Liu, M. Carbon Nanotube Ink Dispersed by Chitin Nanocrystals for Thermoelectric Converter for Self-Powering Multifunctional Wearable Electronics. Adv. Sci. (Weinh) 2022, 9(33), e2204675. doi.org/10.1002/advs.202204675.
80. Somasundaram, S.; Kumaravel, V. Application of Nanoparticles for Self-Cleaning Surfaces. In: Home Emerging Nanostructured Materials for Energy and Environmental Science, 2019. Part of the Environmental Chemistry for a Sustainable World book series (ECSW, volume 23).
81. Yang, N.; Xi, C. Sustainability: don't waste seafood waste. Nature 2015, 524, 155-157. doi.org/10.1038/524155a.
82. Chandrasekharan, M.; Sachindra, N. M.; Mahendrakar N. S. Biotechnology for utilization of marine by-products. In Fish Processing By products, Studium Press, Texas, 2015, pp. 43-62.
83. Joseph, B.; Sam, R. M.; Balakrishnan, P.; Maria, H. J.; Gopi, S.; Volova, T.; Fernandes, S. C. M.; Thomas, S. Extraction of Nanochitin from Marine Resources and Fabrication of Polymer Nanocomposites: Recent Advances. Polymers (Basel) 2020, 12(8), 1664. doi.org/10.3390/polyml2081664.
84. Druzian, S. P.; Zanatta, N. P.; Côrtes, L. N.; Fátima, A.; Streit, M. Preparation of Chitin Nanowhiskers and Its Application for Crystal Violet Dye Removal from Wastewaters. 2019, 28548-28557. doi.org/10.1007/s11356-018-3547-0.
85. Revol, J.; Marchessaultf, R. H. In Vittro Chiral Nematic Ordering of Chitin Crystallites. Int. J. Biol. Macromol. 1993, 15, 329-335. doi.org/10.1016/0141-8130(93)90049-r.
86. Yamamoto, Y.; Nishimura, T.; Saito, T.; Kato, T. CaCO3/Chitin-Whisker Hybrids: Formation of CaCO3 Crystals in Chitin-Based Liquid-Crystalline Suspension. Polym. J. 2010, 42 (7), 583-586. doi.org/10.1038/pj.2010.32.
87. Qi, G. Chitin nanowhisker composites and methods. CN105408421A.
88. Poeloengasih C. D.; Hernawan, D.; Angwarndo, M. Isolation and Characterization of Xhitin and Chitosan Prepared under Various Processing Times. Indo. J. Chem. 2008, 8, 189-192. doi.org/10.22146/ijc.21635.
89. Beaney, P.; Lizardi-Mendoza, J.; Healy, M. Comparison of chitins produced by chemical and bioprocessing methods. J. Chem. Tech. Biotech. 2005, 80, 145-150. doi.org/10.1002/jctb.1164.
90. Rinaudo, M. Chitin and chitosan: Properties and applications. Prog. Polym. Sci. 2006, 31, 603-632. doi.org/10.1016/j.progpolymsci.2006.06.001.
91. Khoushab, F.; Yamabhai, M. Chitin Research Revisited. Mar. Drugs 2010, 8, 1988-2012. doi.org/10.3390/md8071988.
92. Jin, T.; Liu, T.; Lam, E.; Moores, A. Chitin and Chitosan on the Nanoscale. Nanoscale Horizons 2021, 6 (7), 505-542. doi.org/10.1039/dOnh00696c.
93. Li, Z.; Zhang, M.; Cheng, D.; Yang, R. Preparation of Silver Nano-Particles Immobilized onto Chitin Nano-Crystals and Their Application to Cellulose Paper for Imparting Antimicrobial Activity. Carbohydr. Polym. 2016, 151, 834-840. doi.org/10.1016/j.carbpol.2016.06.012.
94. Ravi Kumar, M. N. V. Reactive & Functional Polym. 2000, 46, 1-27. doi.org/10.1016/S1381-5148(00)00038-9.
95. Shamshina, J. L.; Barber, P. S.; Gurau, G. Pulping of Crustacean Waste Using Ionic Liquids: To Extract or Not To Extract. ACS Sust. Chem. Eng. 2017, 4, 6072-6081. doi.org/10.1021/acssuschemeng.6b01434.

What is claimed is:

1. A method for the preparation of chitin nanocrystals, nanowhiskers, or both directly from a raw chitinous biomass without the prior isolation of a raw chitin polymer using an ionic liquid comprising:
isolating chitin nanocrystals and nanowhiskers by hydrolyzing a raw, unpurified chitinous biomass with an ionic liquid, wherein the chitin nanocrystals and nanowhiskers comprise at least one of a high aspect ratio, are highly crystalline, or have high thermal stability.

2. The method of claim 1, wherein the ionic liquid comprises at least one cation and at least one anion that form an ion pair or an ion complex.

3. The method of claim 1, wherein the ionic liquid comprises an acidic ionic liquid, a Brönsted acidic ionic liquid, comprising one or more cations and one or more anions.

4. The method of claim 1, wherein the anion for the ionic liquid cation is a Bronsted-acidic anion (acidic IL), wherein,
the acidic IL is with [HSO₄]⁻-anion; 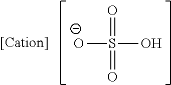
the acidic IL is with [RSO₄]⁻-anion, where R=C1-C6 alkyl or a C1-C6 alkoxyalkyl group, or substituted alkyl/alkoxyalkyl 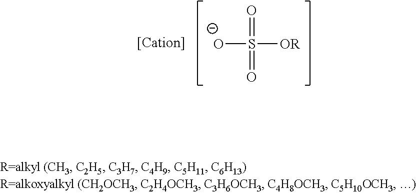
the acidic IL is with [HSO₃]⁻-anion; 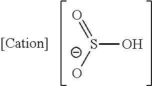
the acidic IL is with [RSO₃]⁻-anion, where R=C1-C6 alkyl or a C1-C6 alkoxyalkyl group, or substituted alkyl/alkoxyalkyl 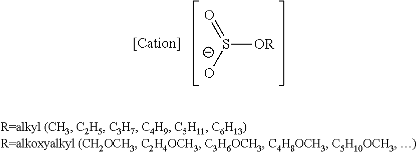
the acidic IL is with [H₂PO₄]⁻-anion; 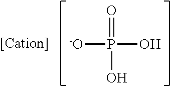
the acidic IL is with [R₁R₂PO₄]⁻-anion, where R₁ and R₂=independently C1-C6 alkyl or a C1-C6 alkoxyalkyl group, or substituted alkyl/alkoxyalkyl; 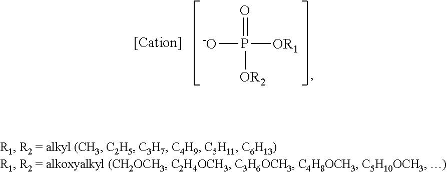
or
the acidic IL is with [No₃]-anion; 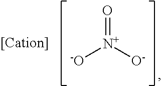
or combination thereof.

5. The method of claim 1, wherein the cation is selected from:
imidazolium or substituted imidazolium 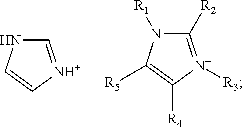
ammonium or substituted ammonium 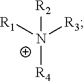
pyridinium or substituted pyridinium 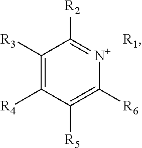
Brönsted acidic ionic liquids with acidic hydrogens on a functional group
alkane sulfonic acid group —SO₃H is covalently tethered to the IL cation 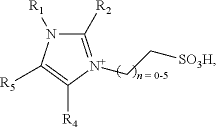
or
protic acidic ionic liquids with acidic hydrogens on cation and anion, or combinations thereof.

6. The method of claim 1, wherein the ionic liquid is 1-ethyl-3-methylimidazolium hydrogen sulfate.

7. The method of claim 1, wherein the raw chitinous biomass comprises at least one of: shrimp shell biomass, crab biomass, lobster biomass, squid pen, fly larvae, or a mixture thereof.

8. The method of claim 1, wherein the ionic liquid is selected from 1-ethyl-3-methylimidazolium [C₂mim] salt.

9. The method of claim 1, wherein the ionic liquid is selected from at least one of: 1-methylimidazolium, 1-ethylimidazolium, 1-propylimidazolium, 1-butylimidazolium, 1-heptyl-3-methylimidazolium, 1-(cyclohexylmethyl)-3-methylimidazolium, 1-benzyl-3-methylimidazolium, 1,3-dibenzylimidazolium, 1-(2-napthylmethyl)-3-methylimidazolium, or 1, 3-dibenzylimidazolium, and mixtures or combination thereof.

10. The method of claim 1, wherein the ionic liquid comprise an acetate salt as the anion is selected from at least one of 1-hepyl-3-methylimidazolium acetate ([C7C1im][OAc]), 1-(cyclohexylmethyl)-3-methylimidazolium acetate ([CyhmC1im][OAc]), 1-benzyl-3-methylimidazolium acetate ([BnzC1im][OAc]), 1,3-dibenzylimidazolium acetate ([(Bnz)2im][OAc]), and 1-(2-napthylmethyl)-3-methylimidazolium acetate ([NapmC1im][OAc]), and mixtures or combination thereof.

11. The method of claim 1, wherein the ionic liquid is a halogen substituted 1-hepyl-3-methylimidazolium halide (X) ([C7C1im]X), 1-(cyclohexylmethyl)-3-methylimidazolium halide ([CyhmC1im]X), 1-benzyl-3-methylimidazolium halide ([BnzC1im]), 1,3-dibenzylimidazolium halide ([(Bnz)2im]X), and 1-(2-napthylmethyl)-3-methylimidazolium halide ([NapmC1im]X), 1-methylimidazolium halide, 1-ethylimidazolium halide, 1-propylimidazolium halide, or 1-butylimidazolium halide, and mixtures or combination thereof.

12. The method of claim 1, wherein the purified chitin comprises rod- or whisker-shaped particles.

13. The method of claim 1, wherein a product from a treatment of crustacean biomass with IL comprises rod- or whisker-shaped particles have dimensions selected from at least one of: 5-20 nm in width, 50-500 nm in length or a high aspect ratio (10-100).

14. The method of claim 1, wherein a yield of chitin nanowhiskers from the raw chitinous biomass is at least 40, 50, 60, or 70%.

15. The method of claim 1, wherein the chitin nanowhiskers comprise rod- or whisker-shaped particles have at least one of: a high aspect ratio, a high modulus (200 GPa), a high stiffness, a high strength, non-toxic, biodegradable, forms crystals, biocompatible, a high binding energy, or a liquid-crystalline behavior.

16. The method of claim 1, further comprising one or more of the following step: mixing the crustacean biomass with an ionic liquid; addition of water; heating the biomass in the IL; washing resultant nanocrystals and nanowhiskers with water; or centrifuging the nanocrystals and nanowhiskers.

17. A method for the preparation of chitin nanocrystals, nanowhiskers, or both directly from a raw chitinous biomass without the prior isolation of a raw chitin polymer using an ionic liquid comprising:
isolating in a single step a purified chitin nanowhiskers by hydrolyzing chitin in an unpurified chitinous biomass, wherein the chitin nanocrystals and nanowhiskers comprise at least one of a high aspect ratio, are highly crystalline, or high thermal stability.

18. The method of claim 17, wherein the ionic liquid is an acidic ionic liquid, a Brönsted acidic ionic liquid, with one or more cations and one or more anions.

19. The method of claim 17, wherein the anion for the ionic liquid cation is a Bronsted-acidic anion (acidic IL), wherein,
the acidic IL is with [HSO₄]⁻-anion; 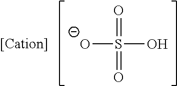
the acidic IL is with [RSO₄]⁻-anion, where R=C1-C6 alkyl or a C1-C6 alkoxyalkyl group, or substituted alkyl/alkoxyalkyl 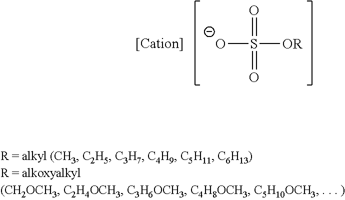
the acidic IL is with [HSO₃]⁻-anion; 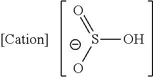
the acidic IL is with [RSO₃]⁻-anion, where R=C1-C6 alkyl or a C1-C6 alkoxyalkyl group, or substituted alkyl/alkoxyalkyl 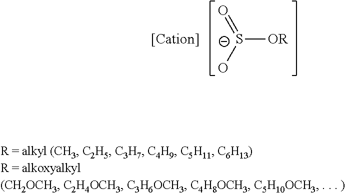
the acidic IL is with [H₂PO₄]⁻-anion; 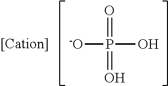
the acidic IL is with [R₁R₂PO₄]⁻-anion, where R₁ and R₂=independently C1-C6 alkyl or a C1-C6 alkoxyalkyl group, or substituted alkyl/alkoxyalkyl; 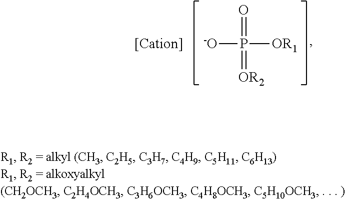
or
the acidic IL is with [NO_{3]}⁻-anion; 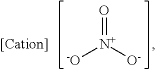
or combinations thereof.

20. The method of claim 17, wherein the cation is selected from:
imidazolium or substituted imidazolium 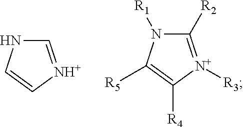
ammonium or substituted ammonium 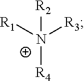
pyridinium or substituted pyridinium 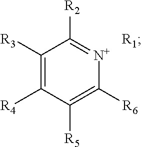
Brönsted acidic ionic liquids with acidic hydrogens on a functional group
alkane sulfonic acid group —SO₃H is covalently tethered to the IL cation 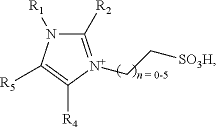
or
protic acidic ionic liquids with acidic hydrogens on cation and anion, or combinations thereof.

21. The method of claim 17, wherein the ionic liquid is 1-ethyl-3-methylimidazolium hydrogen sulfate.

22. The method of claim 17, wherein the raw chitinous biomass comprises at least one of: shrimp shell biomass, crab biomass, lobster biomass, squid pen, fly larvae, or a mixture thereof.

23. The method of claim 17, wherein the ionic liquid is selected from 1-ethyl-3-methylimidazolium [C₂mim] salt.

24. The method of claim 17, wherein the ionic liquid is selected from at least one of: 1-methylimidazolium, 1-ethylimidazolium, 1-propylimidazolium, 1-butylimidazolium, 1-heptyl-3-methylimidazolium, 1-(cyclohexylmethyl)-3-methylimidazolium, 1-benzyl-3-methylimidazolium, 1,3-dibenzylimidazolium, 1-(2-napthylmethyl)-3-methylimidazolium, or 1, 3-dibenzylimidazolium, and mixtures or combination thereof.

25. The method of claim 17, wherein the ionic liquid comprise an acetate salt as the anion is selected from at least one of 1-hepyl-3-methylimidazolium acetate ([C7C1im][OAc]), 1-(cyclohexylmethyl)-3-methylimidazolium acetate ([CyhmC1im][OAc]), 1-benzyl-3-methylimidazolium acetate ([BnzC1im][OAc]), 1,3-dibenzylimidazolium acetate ([(Bnz)2im][OAc]), and 1-(2-napthylmethyl)-3-methylimidazolium acetate ([NapmC1im][OAc]), and mixtures or combination thereof.

26. The method of claim 17, wherein the ionic liquid is a halogen substituted 1-hepyl-3-methylimidazolium halide (X) ([C7C1im]X), 1-(cyclohexylmethyl)-3-methylimidazolium halide ([CyhmC1im]X), 1-benzyl-3-methylimidazolium halide ([BnzC1im]), 1,3-dibenzylimidazolium halide ([(Bnz)2im]X), and 1-(2-napthylmethyl)-3-methylimidazolium halide ([NapmC1im]X), 1-methylimidazolium halide, 1-ethylimidazolium halide, 1-propylimidazolium halide, or 1-butylimidazolium halide, and mixtures or combination thereof.

27. The method of claim 17, wherein the purified chitin comprises rod- or whisker-shaped particles.

28. The method of claim 17, wherein the purified chitin comprises rod- or whisker-shaped particles have dimensions selected from at least one of: 5-20 nm in width, 50-500 nm in length or a high aspect ratio (10-100).

29. The method of claim 17, wherein a yield of chitin from the raw chitinous biomass is at least 40, 50, 60, or 70%.

30. The method of claim 17, wherein the purified chitin comprises rod- or whisker-shaped particles have at least one of: a high aspect ratio, a high modulus (200 GPa), a high stiffness, a high strength, non-toxic, biodegradable, forms crystals, biocompatible, a high binding energy, or a liquid-crystalline behavior.

31. The method of claim 17, further comprising the step of mixing the purified chitin to form a regenerative polymer, a bio-degradable polymer, or both.

32. The method of claim 17, further comprising one or more of the following step: mixing the purified chitin in water; heating the purified chitin; washing the purified chitin with water; or centrifuging the purified chitin.

33. A purified chitin nanocrystal made by a single step method, wherein the purified chitin is separated from a raw chitinous biomass without the prior isolation of a raw chitin polymer, the method comprising:
extracting a purified chitin by hydrolyzing with an ionic liquid from the raw chitinous biomass, wherein the chitin nanocrystals and nanowhiskers comprise at least one of: a high aspect ratio, are crystalline, or have a high thermal stability.

34. The purified chitin nanocrystal of claim 33, wherein the ionic liquid is 1-ethyl-3-methylimidazolium hydrogen sulfate.

35. The purified chitin nanocrystal of claim 33, wherein the raw chitinous biomass comprises at least one of: shrimp shell biomass, crab biomass, lobster biomass, squid pen, fly larvae, or a mixture thereof.
